(19) United States
(12) Patent Application Publication
(10) Pub. No.: US 2013/0083844 A1
(43) Pub. Date: Apr. 4, 2013

(54) COEFFICIENT CODING FOR SAMPLE ADAPTIVE OFFSET AND ADAPTIVE LOOP FILTER

(71) Applicants: In Suk Chong, San Diego, CA (US); Sanjeev Kumar, San Diego, CA (US); Marta Karczewicz, San Diego, CA (US)

(72) Inventors: In Suk Chong, San Diego, CA (US); Sanjeev Kumar, San Diego, CA (US); Marta Karczewicz, San Diego, CA (US)

(21) Appl. No.: 13/627,457

(22) Filed: Sep. 26, 2012

Related U.S. Application Data
(60) Provisional application No. 61/541,977, filed on Sep. 30, 2011.
(60) Provisional application No. 61/552,266, filed on Oct. 27, 2011.

(51) Int. Cl. H04N 7/32

(52) U.S. Cl. 375/240.02; 375/240.14; 375/E07.243; 375/E07.245

(57) ABSTRACT

Techniques for coding both edge and band offset values are described. Offset values may be predicted such that one offset value in a group of offset values is predicted from another offset value in the group. In addition, offset values of a partition may be predicted from offset values of a neighboring partition. Offset values may also be right shifted to be at a lower precision before signaling in the encoded video bitstream. A video decoding device may apply the techniques to filter a current partition based on offset values associated with a neighboring partition.

### RELATED APPLICATIONS

This application claims the benefit of:

U.S. Provisional Application No. 61/541,977, filed Sep. 30, 2011; and

U.S. Provisional Application No. 61/552,266, filed Oct. 27, 2011, each of which are hereby incorporated by reference in their respective entirety.

### TECHNICAL FIELD

This disclosure relates to video coding, and more particularly to techniques for coding and signaling sample adaptive offset values and/or filter coefficients for an adaptive loop filter.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, digital cameras, digital recording devices, digital media players, video gaming devices, video game consoles, cellular or satellite radio telephones, so-called “smart phones,” video teleconferencing devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards, to transmit, receive and store digital video information more efficiently.

Video compression techniques include spatial prediction and/or temporal prediction to reduce or remove redundancy inherent in video sequences. For block-based video coding, a video frame or slice may be partitioned into blocks. Each block can be further partitioned. Blocks in an intra-coded (I) frame or slice are encoded using spatial prediction with respect to reference samples in neighboring blocks in the same frame or slice. Blocks in an inter-coded (P or B) frame or slice may use spatial prediction with respect to reference samples in neighboring blocks in the same frame or slice or temporal prediction with respect to reference samples in other reference frames. Spatial or temporal prediction results in a predictive block for a block to be coded. Residual data represents pixel differences between the original block to be coded and the predictive block.

An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in a particular order to produce a one-dimensional vector of transform coefficients for entropy coding.

### SUMMARY

In general, this disclosure describes techniques for coding video data. In particular, this disclosure describes techniques for coding and signaling sample adaptive offset (SAO) values and/or filter coefficients for an adaptive loop filtering (ALF).

According to one example of the disclosure, a method of filtering video data comprises receiving a current partition of a video coding unit, receiving a modified offset value associated with the current partition, receiving one or more predictor offset values, generating a group of offset values for the current partition based on the modified offset value and the one or more predictor offset values, and filtering the current partition based on the generated group of offset values.

According to another example of the disclosure, a method of encoding filter offset values in a video coding process comprises determining a group of offset values for a current partition of a video coding unit, determining one or more predictor offset values, generating a modified offset value by modifying one of the offset values in the group of offset values based on the one or more predictor offset values, and signaling the modified offset value and the one or more predictor offset values in an encoded video bitstream.

According to another example of the disclosure an apparatus configured to filter video data comprises means for receiving a current partition of a video coding unit, means for receiving a modified offset value associated with the current partition, means for receiving one or more predictor offset values, means for generating a group of offset values for the current partition based on the modified offset value and the one or more predictor offset values, and means for filtering the current partition based on the generated group of offset values.

According to another example of the disclosure an apparatus configured to encode filter offset values comprises means for determining a group of offset values for a current partition of a video coding unit, means for determining one or more predictor offset values, means for generating a modified offset value by modifying one of the offset values in the group of offset values based on the one or more predictor offset values, and means for signaling the modified offset value and the one or more predictor offset values in an encoded video bitstream.

According to another example of the disclosure a device comprises a video decoder configured to receive a current partition of a video coding unit, receive one or more predictor offset values, generate a group of offset values for the current partition based on the one or more predictor offset values, and filter the current partition based on the generated group of offset values.

According to another example of the disclosure a device comprises a video encoder configured to determine a group of offset values for a current partition of a video coding unit, determine one or more predictor offset values, generate a modified offset value by modifying one of the offset values in the group of offset values based on the one or more predictor offset values, and signal the modified offset value and the one or more predictor offset values in an encoded video bitstream.

According to another example of the disclosure a non-transitory computer-readable storage medium has instructions stored thereon that upon execution cause one or more processors of a video coding device to receive a current partition of a video coding unit, receive one or more predictor offset values, generate a group of offset values for the current partition based on the one or more predictor offset values, and filter the current partition based on the generated group of offset values.

According to another example of the disclosure a non-transitory computer-readable storage medium has instructions stored thereon that upon execution cause one or more processors of a video encoding device to determine a group of offset values for a current partition of a video coding unit, determine one or more predictor offset values, generate a modified offset value by modifying one of the offset values in the group of offset values based on the one or more predictor offset values, and signal the modified offset value and the one or more predictor offset values in an encoded video bitstream.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual diagram illustrating example edge offset classifications.

FIG. 2 is a conceptual diagram illustrating example band offset classifications.

FIG. 3 is a block diagram illustrating an example video encoding and decoding system.

FIG. 4 is a block diagram illustrating an example video encoder.

FIGS. 5A and 5B are block diagrams illustrating an example SAO/ALF module included in a video encoder.

FIGS. 6A and 6B are conceptual diagrams illustrating examples of a current partition and neighboring partitions of a video frame or picture.

FIG. 7 is a flowchart illustrating an example of encoding offset values according to the techniques of this disclosure.

FIG. 8 is a block diagram illustrating an example video decoder.

FIG. 9 is a block diagram illustrating an example SAO/ALF module included in a video decoder.

FIG. 10 is a flowchart an example of applying offset values according to the techniques of this disclosure.

### DETAILED DESCRIPTION

In general, this disclosure describes techniques for filtering video data. This disclosure describes techniques for coding and signaling SAO values and coefficients for an ALF. In particular, this disclosure describes techniques for reducing the number of bits required to signal SAO values and/or ALF coefficients. SAO values and ALF coefficients are typically derived at a video encoder based on an original video frame and a reconstructed video frame. Typically, a video encoder explicitly includes the SAO values and ALF coefficients in an encoded bitstream for use by a video decoder. In some cases, the range of possible SAO values may be a factor of the bit depth of the original video frame and each video block of a video frame may include multiple offset values. Thus, explicitly signaling SAO values and ALF coefficients for each video block of a video frame may require a significant number of bits. Techniques disclosed herein allow a video decoder to derive SAO values and ALF coefficients from a bitstream that includes a reduced number of bits to signal the SAO values and ALF coefficients.

Digital video devices implement video compression techniques to encode and decode digital video information more efficiently. Video compression techniques may be defined according to a video coding standard. Examples of video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multiview Video Coding (MVC) extensions. In addition, there is a new video coding standard, namely High-Efficiency Video Coding (HEVC), being developed by the Joint Collaboration Team on Video Coding (JCT-VC) of ITU-T Video Coding Experts Group (VCEG) and ISO/IEC Motion Picture Experts Group (MPEG).

HEVC standardization efforts are based on a model of a video coding device referred to as the HEVC Test Model (HM). The HM presumes improvements in the capabilities of current video coding devices with respect to video coding devices available during the development of other previous video coding standards, e.g., ITU-T H.264/AVC, were developed. For example, whereas H.264 provides nine intra-prediction encoding modes, HEVC provides as many as thirty-five intra-prediction encoding modes. A recent working Draft (WD) of HEVC, referred to as “HEVC Working Draft 4” or “WD4,” is described in document JCTVC-F803 d2, Bross et al., “WD4: Working Draft 4 of High-Efficiency Video Coding (HEVC),” Joint Collaborative Team on Video Coding (JCT-VC) of ITU-T SG16 WP3 and ISO/IEC JTC1/SC29/WG11, 6th Meeting: Torino, IT, July, 2011. Further, another recent working draft of HEVC, Working Draft 8, is described in document HCTVC-J1003 d7, Bross et al., “High Efficiency Video Coding (HEVC) Text Specification Draft 8,” Joint Collaborative Team on Video Coding (JCT-VC) of ITU-T SG16 WP3 and ISO/IEC JTC1/SC29/WG11, 10th Meeting: Stockholm, SE, Jul. 11-20, 2012. The HEVC standard may also be referred to as ISO/IEC 23008-HEVC, which is intended to be the standard number for the delivered version of HEVC.

A typical video encoder operating according to a video coding standard, such as HEVC WD4, partitions each frame of the original video sequence into contiguous rectangular regions called “blocks” or “coding units.” These blocks may be encoded by applying spatial (intra-frame) prediction and/or temporal (inter-frame) prediction techniques to reduce or remove redundancy inherent in video sequences. A spatial prediction may be referred to as an “intra mode” (I-mode), and a temporal prediction may be referred to as an “inter mode” (P-mode or B-mode).

For inter mode, the encoder first searches a “reference frame” (denoted by F_{ref}) for a block that is similar to the one to be coded. The location of the block to be coded within the frame may be denoted by (x, y). Searches are generally restricted to being no more than a certain spatial displacement from the block to be encoded. When the best match, i.e., predictive block or “prediction,” has been identified, it may be expressed in the form of a two-dimensional (2D) motion vector (Δx, Δy), where Δx is the horizontal displacement and Δy is the vertical displacement of the position of the predictive block in the reference frame relative to the position of the block to be coded. The motion vectors together with the reference frame are used to construct predicted block F_{pred} as follows:

F_{pred}(x,y)=F_{ref}(x+Δx,y+Δy)

For blocks encoded in intra mode, the predicted block is formed using spatial prediction from previously encoded neighboring blocks within the same frame as the block to be coded.

For both I-mode and P or B-mode, the prediction error, i.e., the difference between the pixel values in the block being encoded and the predicted block, may be represented as a set of weighted basis functions of some discrete transform, such as a discrete cosine transform (DCT). Transforms may be performed based on different sizes of blocks, such as 4×4, 8×8 or 16×16 and larger. Rectangular shaped transform blocks may also be used, e.g., with a transform block size of 16×4, 32×8, etc. The weights (i.e., the transform coefficients) may subsequently be quantized. Quantized coefficients may have a lower precision than the original transform coefficients. As such, quantization may introduce a loss of information. A quantization parameter (QP) may determine the level of precision of the quantized coefficients.

These quantized coefficients and syntax elements, such as motion vectors, plus some control information, may form a coded representation of the video sequence. Further, quantized coefficients, syntax elements and control information may also be entropy coded, thereby further reducing the number of bits needed for their representation. Entropy coding is a lossless operation aimed at minimizing the number of bits required to represent transmitted or stored symbols based on a probability distribution (i.e., coding symbols based the frequency that they occur). The compression ratio, i.e., the ratio of the number of bits used to represent the original sequence versus the number of bits used to represent the coded video sequence, may be controlled by adjusting the value of the QP used when quantizing transform coefficients. However, adjusting the value QP may affect the visual quality of the coded video sequence. The compression ratio may also depend on the method of entropy coding employed. At a decoder, a block in a current frame to be decoded may be reconstructed by adding a prediction error to an identified predictive block. Due to information losses in the coding process, in some cases, the reconstructed frame may be different from the original frame. The difference between the reconstructed frame and the original frame is called reconstruction error.

For video coding according to HEVC WD4, as one example, a video frame may be partitioned into coding units. A coding unit (CU) generally refers to an image region that serves as a basic unit to which various coding tools are applied for video compression. A CU usually has a luminance component, denoted as Y, and two chroma components, denoted as U and V. The two chroma components may also be denoted by C_{b} and Cᵣ. A video sampling format may define the number of chroma samples with respect to the number of luma samples. In some video sampling formats, the number of chroma samples may be the same as or different from the number of luma samples. A CU is typically square, and may be considered to be similar to a so-called “macroblock” described in other video coding standards such as, for example, ITU-T H.264. Coding according to some of the presently proposed aspects of the developing HEVC standard will be described in this application for purposes of illustration. However, the techniques described in this disclosure may also be useful for and applied to other video coding processes, such as those defined according to ITU-T H.264 or other standard or proprietary video coding processes.

According to the HEVC WD4, a CU may include one or more prediction units (PUs) and/or one or more transform units (TUs). Syntax data within a bitstream may define a largest coding unit (LCU), which is a largest CU in terms of the number of pixels. In general, a CU has a similar purpose to a macroblock of H.264, except that a CU does not have a size distinction. Thus, an LCU may be split into sub-CUs, and each sub-CU may be further split into sub-CUs. Further, CUs may be partitioned into prediction PUs for purposes of prediction. A PU may represent all or a portion of the corresponding CU, and may include data for retrieving a reference sample for the PU. PUs may have square or rectangular shapes. TUs represent a set of pixel difference values or pixel residuals that may be transformed to produce transform coefficients. Syntax data for a bitstream may define a maximum number of times an LCU may be split, referred to as CU depth. Accordingly, a bitstream may also define a smallest coding unit (SCU). This disclosure also uses the term “block”, “partition,” or “portion” to refer to any of a CU, PU, or TU. In general, “portion” may refer to any sub-set of a video frame.

Further, HEVC WD4 describes a sample adaptive offset (SAO) coding technique. Additional SAO coding techniques have been proposed for possible inclusion in the HEVC standard. One example SAO coding technique is described in C.-M. Fu, C.-Y. Chen, C.-Y. Tsai, Y.-W. Huang, S. Lei, “CE13: Sample Adaptive Offset with LCU-Independent Decoding,” JCT-VC Contribution, E049, Geneva, March 2011 (hereinafter “JCT-VC E049”). In general, SAO coding techniques are filtering techniques that add offset values to pixels in a video frame. In some cases offset values may be added to pixels in a reconstructed video frames. The reconstructed frame with offset values may further be used as a reference video frame and/or output to a display. SAO techniques may be executed in the in-loop filter block of a video encoder or decoder in conjunction with other filtering techniques

As described above, predictive coding may result in a reconstruction error. The addition of offset values to pixels in a reconstructed video frame may improve coding during illumination changes between frames of a video sequence (e.g., such as during flashes, a darkening sky, or other types of illumination changes between frames). Such illumination changes may add a relatively uniform intensity change across regions of pixels in the frame. SAO techniques may apply offset values to pixels of a predicted video block in order to bias the values of the predictive video block so as to compensate for illumination changes. SAO techniques may determine and apply offset values to a pixel by classifying a pixel according to a classification metric. A classification metric may also be referred to as pixel classification or an offset type. Further, the result of classifying a pixel according to a classification metric may also be referred to as an offset type, pixel offset type, category or pixel category. Possible classification metrics include activity metrics such as edge metrics and band metrics.

Some SAO techniques include multiple pixel classifications techniques. Some video coding standards may limit the number of different pixel classifications that may be applied per frame (e.g., one technique per frame), while others may allow for more flexibility by allowing different pixel classifications to be applied on a block-by-block or pixel-by-pixel basis. It should be noted that the number of pixel classification types that are allowed to be applied, and the frequency at which different pixel classifications are allowed to be applied in a video frame, may affect coding efficiency.

HEVC WD4 describes a possible SAO implementation for HEVC where each partition (which consists of a set of LCUs) can have one of three pixel classifications: no offset, edge classification based type, and band classification based offset type. Further, the edge classification based type includes four edge offset classifications: 1D 0-degree edge (also referred to as SAO edge offset of classification zero or SAO_EO₋0), 1D 90-degree edge (also referred to as SAO edge offset of classification one or SAO_EO_{—}1), 1D 135-degree edge (also referred to as SAO edge offset of classification two or SAO_EO₋2), and 1D 45-degree edge (also referred to as SAO edge offset of classification three or SAO_EO₋3). Band classification based offset type includes two band offset type classifications: central band and side band.

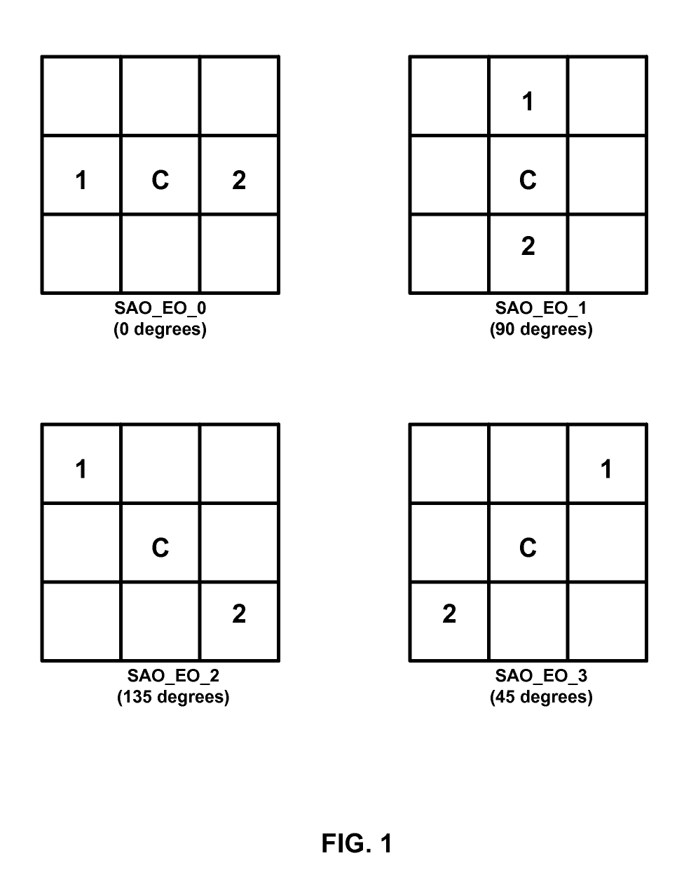

An edge classification based type SAO technique classifies each pixel within a partition based on edge information. FIG. 1 is a conceptual diagram showing four possible edge offset classifications. JCT-VC E049 describes one example of an edge classification technique that includes the four edge offset type classifications described above. For a given edge classification shown in FIG. 1, an edge type for the current pixel is calculated by comparing the value of the current pixel (C) to the values of neighboring pixels (1 and 2). In some examples, pixel values may be an 8-bit string including 256 possible values or a 10-bit string including 1024 possible values. For SAO_EO₋0, the current pixel is compared to the left and right neighbor pixels. For SAO_EO₋1, the current pixel is compared to the top and bottom neighbor pixels. For SAO_EO₋2, the current pixel is compared to the upper left and bottom right neighbor pixels. For SAO_EO₋3, the current pixel is compared to the bottom left and upper right neighbor pixels.

Initially, the edge type of the current pixel is assumed to be zero. If the value of current pixel C is equal to values of both the left and right neighbor pixels (1 and 2), the edge type remains at zero. If the value of the current pixel C is greater than the value of neighbor pixel 1, the edge type is increased by one. If the value of the current pixel C is less than the value of neighbor pixel 1, the edge type is decreased by one. Likewise, if the value of the current pixel C is greater than the value of neighbor pixel 2, the edge type is increased by one, and if the value of the current pixel C is less than the value of the neighbor pixel 2, the edge type is decreased by 1.

As such, the current pixel C may have an edge type of either −2, −1, 0, 1, or 2, where (1) the edge type is −2 if the value of current pixel C is less than both values of neighbor pixels 1 and 2; (2) the edge type is −1 if the value of current pixel C is less than one neighbor pixel, but equal to the other neighbor pixel; (3) the edge type is 0 if the value of current pixel C is the same as both neighbor pixels, or if the value of current pixel C is greater than one neighbor pixel, but less than the other neighbor pixel; (4) the edge type is 1 if the value of the current pixel C is greater than one neighbor pixel, but equal to the other neighbor pixel; and (5) the edge type is 2 if the value of the current pixel C is greater than both values of neighbor pixels 1 and 2. It should be noted that when one of neighboring pixels 1 and 2 is not available (i.e., current pixel C is located at the edge of a frame or partition), a default edge type may be defined.

In view of the above description, for each edge offset classification, edge type values may be computed with the following equations:

EdgeType=0;

if(C>Pixel 1)EdgeType=EdgeType+1;

if(C<Pixel 1)EdgeType=EdgeType−1;

if(C>Pixel 2)EdgeType=EdgeType+1;

if(C<Pixel 2)EdgeType=EdgeType−1;

Once an edge type is determined for a current pixel an offset value can be determined for the current pixel. Offset values are based on the difference between the original video frame and the reconstructed video frame. In one example, each non-zero edge type value (i.e., −2, −1, 1, and 2) has one offset value calculated by taking an average of differences between the values of original and reconstructed pixels belonging to each category in a partition. The four offset values may be denoted as eoffset₂, eoffset₋₁, eoffset₁, and eoffset₂. Because each of eoffset₂, eoffset₋₁, eoffset₁, and eoffset₂ is based on the original video frame, which is not available at a video decoder, a video decoder includes a mechanism to derive the four offset values without relying of the original video frame.

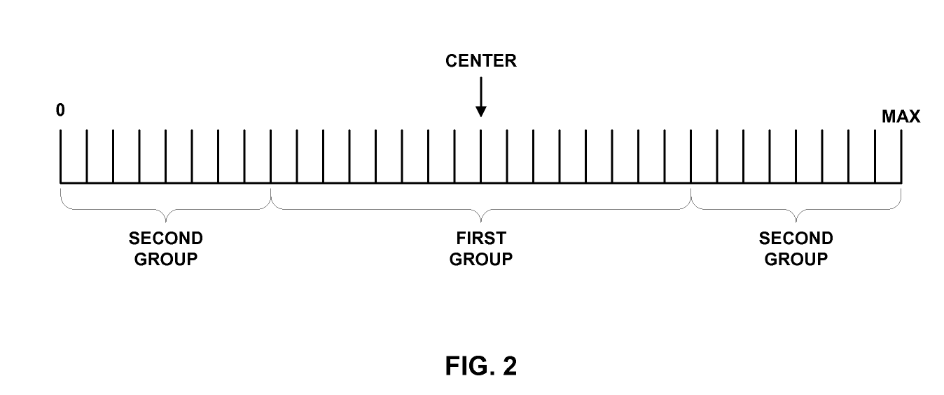

Band classification based offset type classification offset classifies pixels into different bands based on their intensity. As described above, band classification based offset type may include two band offset type classifications: central band and side band. FIG. 2 is a conceptual diagram showing an example band classification based offset type including a central band and a side band. As shown in FIG. 2 each of pixel intensities 0 to MAX may be categorized into one of 32 bands. In one example, pixels may have 8-bit intensity values and MAX may equal 255. In the example of FIG. 2, the 16 bands in the center are classified into a first group and the remaining side bands are classified into a second group. In a manner similar to edge type band offset, once a band type is determined for a current pixel an offset value can be determined for the current pixel based on the difference between the original video frame and the reconstructed video frame. In one example, each band type value (i.e., 0 to 31) has one offset value calculated by taking an average of differences between the values of original and reconstructed pixels belonging to each band type category in a partition. Thus, for each group of bands (i.e., first group and second group), 16 offset values are determined. The 16 offset values for each group may be denoted as boffset₀, . . . , boffset₁₅. As with eoffset₋₂, eoffset₋₁, eoffset₁, and eoffset₂, each of boffset₀, . . . , boffset₁₅ is based on the original video frame and a video decoder includes a mechanism to derive the 16 offset values.

Typically, an encoded video bitstream includes information indicating one of the six pixel classification types and a corresponding set of offsets (i.e., eoffset₋₂, . . . , eoffset₂ and boffset₀, . . . , boffset₁₅) for each partition of a video frame. In some cases, each offset value in a set offset values is independently coded using signed unary coding on a partition-by-partition basis. Independently coding offset values using signed unary coding fails to exploit possible correlations between offset values within a set offset values or between offset values of neighboring partitions (or partitions from previous frames). Thus, independently coding offset values using signed unary coding may not provide the most efficient bit rate.

Further, as described above, SAO techniques may be executed in conjunction with additional filtering techniques. Additional filtering techniques may include, for example, Weiner filtering techniques. Similar to the calculation of offset values for SAO techniques, additional filtering techniques may calculate filter coefficients based on the difference between the original frame and the reconstructed frame. For example, filter coefficients for a Weiner filter may be determined based on the difference between the original picture and a reconstructed picture. Like offset values, calculated coefficients may also be included in the bitstream for use by a video decoder.

HEVC WD4 also describes an adaptive loop filter (ALF) process. In the ALF process described in HEVC WD4, a filtered pixel value is derived by taking a summation of adjusted values of current and neighboring pixels within a partition of a video block, wherein the values of current and neighboring pixels are adjusted by multiplying calculated AC coefficients and adding DC coefficients to the current and neighboring pixels. The value of the summation may further be normalized by dividing the result of the summation by the total number pixels included in partition. The equation below provides an example equation for calculating a filtered pixel using AC and DC coefficients, wherein the pixel is included in partition of size 1 by m and bit_shift is a normalizing factor:

Filtered pixel(x,y)=(sum_{1,m}(prefiltered pixel(x+1,y+m)*AC coefficients(l,m))+DCcoefficients)>>bit_shift.

Because the SAO process adds an offset value to pixels, in some cases, the addition of DC coefficients to SAO filtered pixels in additional filtering processes may be redundant. Further, currently in HEVC WD4, the AC coefficients for the ALF process utilize the same N bit precision as the DC coefficients. However, this may lead to inefficiencies in bit rate, as the precision for the DC coefficients need not be as high as the precision for the AC coefficients. Additionally, not all AC coefficients benefit from the higher N bit precisions. In view of the following, this disclosure presents techniques for coding and signaling offset values used in a SAO filtering process and coefficients used in other filtering processes.

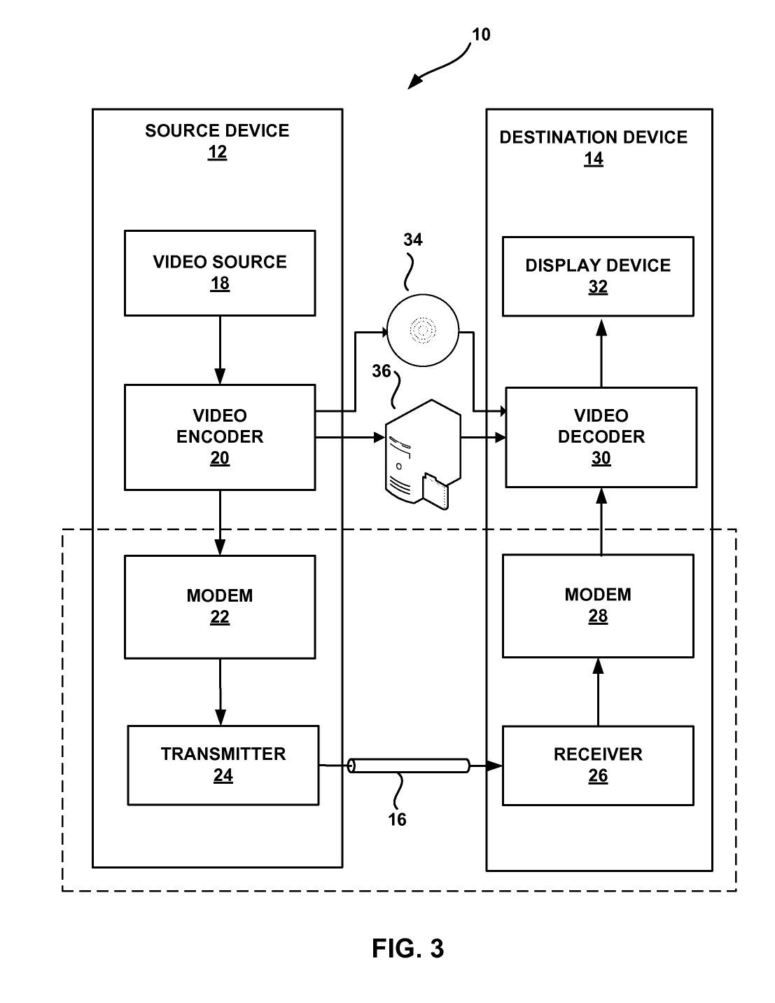

FIG. 3 is a block diagram illustrating an example video encoding and decoding system 10 that may be configured to utilize techniques for coding and signaling sample adaptive offset values in accordance with examples of this disclosure. Further, system 10 may also be configured to utilize techniques for signaling and coding AC coefficients for an ALF. As shown in FIG. 3, system 10 includes source device 12 and destination device 14. Source device 12 may be configured to transmit encoded video to destination device 14 via a communication channel 16 or to file server 36 which may be accessed by the destination device 14 as desired. Source device 12 and destination device 14 may comprise any of a wide variety of devices, including desktop computers, notebook (i.e., laptop) computers, tablet computers, set-top boxes, telephone handsets such as so-called smartphones, televisions, cameras, display devices, digital media players, video gaming consoles, or the like. In many cases, such devices may be equipped for wired and/or wireless communication. Hence, communication channel 16 may comprise any wireless or wired communication medium, such as a radio frequency (RF) spectrum or one or more physical transmission lines, or any combination of wireless and wired media. Communication channel 16 may form part of a packet-based network, such as a local area network, a wide-area network, or a global network such as the Internet. Communication channel 16 generally represents any suitable communication medium, or collection of different communication media, for transmitting video data from source device 12 to destination device 14, including any suitable combination of wired or wireless media. Communication channel 16 may include routers, switches, base stations, or any other equipment that may be useful to facilitate communication from the source device 12 to the destination device 14.

Similarly, file server 36 may be accessed by source device 12 and destination device 14 through any standard data connection, including an Internet connection. This may include a wireless channel (e.g., a Wi-Fi connection), a wired connection (e.g., DSL, cable modem, Ethernet, USB, etc.), or a combination of both that is suitable for accessing encoded video data stored on file server 36. File server 36 may be any type of server capable of storing encoded video and transmitting encoded video to the destination device 14. Example file servers include a web server (e.g., for a website), an FTP server, network attached storage (NAS) devices, a local disk drive, or any other type of device capable of storing encoded video data and transmitting it to a destination device. The transmission of encoded video data from the file server 36 may be a streaming transmission, a download transmission, or a combination of both.

Source device 12 may also be configured to store encoded video data on storage medium 34. Storage medium 34 may include Blu-ray discs, DVDs, CD-ROMs, flash memory, or any other suitable digital storage media for storing encoded video. When encoded video data is stored to storage medium 34 or file server 36, video encoder 20 may provide coded video data to another device, such as a network interface, a compact disc (CD), Blu-ray or digital video disc (DVD) burner or stamping facility device, or other devices, for storing the coded video data to the storage medium. Likewise, a device separate from video decoder 30, such as a network interface, CD or DVD reader, or the like, may retrieve coded video data from a storage medium and provided the retrieved data to video decoder 30.

Techniques for coding and signaling sample adaptive offset values and filter coefficients, in accordance with examples of this disclosure, may be applied to video coding in support of any of a variety of multimedia applications, such as over-the-air television broadcasts, cable television transmissions, satellite television transmissions, streaming video transmissions, e.g., via the Internet, encoding of digital video for storage on a data storage medium, decoding of digital video stored on a data storage medium, or other applications. In some examples, the system 10 may be configured to support one-way or two-way video transmission to support applications such as video streaming, video playback, video broadcasting, and/or video telephony.

In the example of FIG. 3, source device 12 includes video source 18, video encoder 20, modulator/demodulator 22 and transmitter 24. Video source 18 may include a source such as a video capture device, such as a video camera, a video archive containing previously captured video, a video feed interface to receive video from a video content provider, and/or a computer graphics system for generating computer graphics data as the source video, or a combination of such sources. In one example, if video source 18 is a video camera, source device 12 and destination device 14 may form so-called camera phones or video phones. However, the techniques described in this disclosure may be applicable to video coding in general, and may be applied to wireless and/or wired applications, or application in which encoded video data is stored on a local disk. Video encoder 20 may encode the captured, pre-captured, or computer-generated video. Encoded video information may be modulated by modem 22 according to a communication standard, such as a wireless communication protocol, and transmitted to destination device 14 via transmitter 24. Modem 22 may include various mixers, filters, amplifiers or other components designed for signal modulation. Transmitter 24 may include circuits designed for transmitting data, including amplifiers, filters, and one or more antennas. Video encoder 20 may store encoded video information onto a storage medium 34 or a file server 36 for later consumption. The encoded video stored on the storage medium 34 may then be accessed by the destination device 14 for decoding and playback.

The destination device 14, in the example of FIG. 3, includes a receiver 26, a modem 28, a video decoder 30, and a display device 32. The receiver 26 of the destination device 14 receives information over the channel 16, and the modem 28 demodulates the information to produce a demodulated bitstream for the video decoder 30. The information communicated over the channel 16 may include a variety of syntax information generated by the video encoder 20 for use by the video decoder 30 in decoding video data. Such syntax may also be included with the encoded video data stored on the storage medium 34 or the file server 36. Each of the video encoder 20 and the video decoder 30 may form part of a respective encoder-decoder (CODEC) that is capable of encoding or decoding video data.

The display device 32 may be integrated with, or external to, the destination device 14. In some examples, the destination device 14 may include an integrated display device and also be configured to interface with an external display device. In other examples, the destination device 14 may be a display device. In general, the display device 32 displays the decoded video data to a user, and may comprise any of a variety of display devices such as a liquid crystal display (LCD), a plasma display, an organic light emitting diode (OLED) display, or another type of display device.

The video encoder 20 and the video decoder 30 may operate according to a video compression standard, such as HEVC and may conform to the HM. Alternatively, the video encoder 20 and the video decoder 30 may operate according to other proprietary or industry standards, such as the ITU-T H.264 standard, or extensions of such standards. The techniques of this disclosure, however, are not limited to any particular coding standard.

Although not shown in FIG. 3, in some aspects, the video encoder 20 and the video decoder 30 may each be integrated with an audio encoder and decoder, and may include appropriate MUX-DEMUX units, or other hardware and software, to handle encoding of both audio and video in a common data stream or separate data streams. If applicable, in some examples, MUX-DEMUX units may conform to the ITU H.223 multiplexer protocol, or other protocols such as the user datagram protocol (UDP).

The video encoder 20 and the video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of the video encoder 20 and the video decoder 30 may be included in one or more encoders or decoders, either of which may be integrated as part of a combined encoder/decoder (CODEC) in a respective device.

The video encoder 20 may implement any or all of the techniques of this disclosure for coding and signaling sample adaptive offset values and filter coefficients in a video encoding process. Likewise, the video decoder 30 may implement reciprocal versions of any or all of these techniques for coding sample adaptive offset values and AC coefficients for an ALF in a video coding process. A video coder, as described in this disclosure, may refer to a video encoder or a video decoder. Similarly, a video coding unit may refer to a video encoder or a video decoder. Likewise, video coding may refer to video encoding or video decoding.

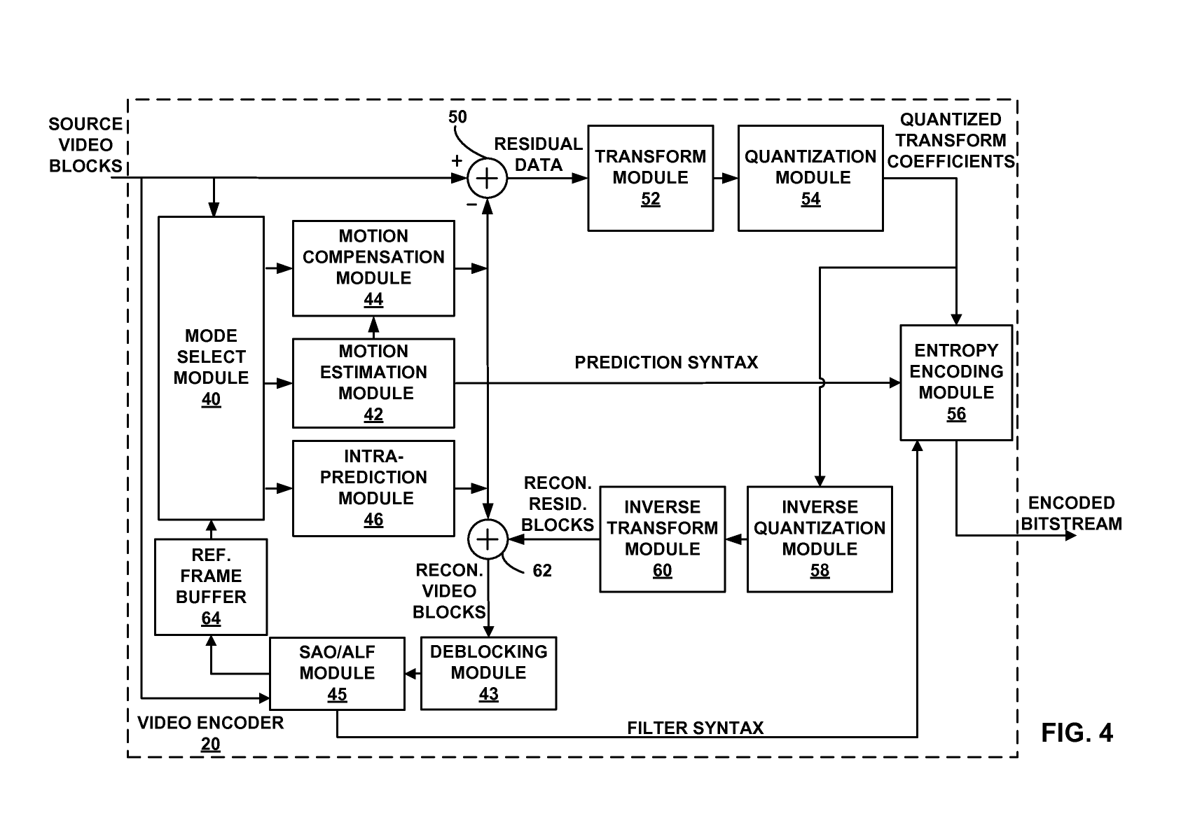

FIG. 4 is a block diagram illustrating an example of a video encoder 20 that may be configured to use techniques for coding and signaling sample adaptive offset values and AC coefficients for an ALF as described in this disclosure. Video encoder 20 will be described in the context of HEVC coding for purposes of illustration, but without limitation of this disclosure as to other coding standards or methods that may require scanning of transform coefficients. Video encoder 20 may perform intra- and inter-coding of CUs within video frames. As described above, intra-coding relies on spatial prediction to reduce or remove spatial redundancy in video data within a given video frame. Inter-coding relies on temporal prediction to reduce or remove temporal redundancy between a current frame and previously coded frames of a video sequence. Intra-mode (I-mode) may refer to any of several spatial-based video compression modes. Inter-modes such as uni-directional prediction (P-mode) or bi-directional prediction (B-mode) may refer to any of several temporal-based video compression modes.

As shown in FIG. 4, the video encoder 20 receives source video blocks within a video frame to be encoded. In the example of FIG. 4, the video encoder 20 includes mode select module 40, motion estimation module 42, motion compensation module 44, intra-prediction module 46, a reference frame buffer 64, a summer 50, a transform module 52, a quantization module 54, and an entropy encoding module 56. Video encoder 20 also includes an inverse quantization module 58, an inverse transform module 60, a summer 62, deblocking module 43, and an SAO/ALF module 45 for video block reconstruction.

During the encoding process, the video encoder 20 receives a video frame or slice to be coded. The motion estimation module 42 and the motion compensation module 44 perform inter-predictive coding of the received video block relative to one or more blocks in one or more reference frames to provide temporal compression. The intra-prediction module 46 may perform intra-predictive coding of the received video block relative to one or more neighboring blocks in the same frame or slice as the block to be coded to provide spatial compression.

As described above, for video coding according to HEVC, a frame or slice may be divided into multiple video blocks (i.e., LCUs, CUs, TUs, and PUs,). An LCU may be associated with a quadtree data structure. In general, a quadtree data structure includes one node per CU, where a root node corresponds to the LCU. If a CU is split into four sub-CUs, the node corresponding to the CU includes four leaf nodes, each of which may correspond to one of the sub-CUs. Each node of the quadtree data structure may provide syntax data for the corresponding CU. For example, a node in the quadtree may include a split flag, indicating whether the CU corresponding to the node is split into sub-CUs. Syntax elements for a CU may be defined recursively, and may depend on whether the CU is split into sub-CUs. If a CU is not split further, it is referred as a leaf-CU. In this disclosure, four sub-CUs of a leaf-CU will also be referred to as leaf-CUs although there is no explicit splitting of the original leaf-CU. For example if a CU at 16×16 size is not split further, the four 8×8 sub-CUs will also be referred to as leaf-CUs although the 16×16 CU was never split.

Moreover, TUs of leaf-CUs may also be associated with respective quadtree data structures. That is, a leaf-CU may include a quadtree indicating how the leaf-CU is partitioned into TUs. This disclosure refers to the quadtree indicating how an LCU is partitioned as a CU quadtree and the quadtree indicating how a leaf-CU is partitioned into TUs as a TU quadtree. The root node of a TU quadtree generally corresponds to a leaf-CU, while the root node of a CU quadtree generally corresponds to an LCU. TUs of the TU quadtree that are not split are referred to as leaf-TUs.

A leaf-CU may include one or more prediction units (PUs). In general, a PU represents all or a portion of the corresponding CU, and may include data for retrieving a reference sample for the PU. For example, when the PU is inter-mode encoded, the PU may include data defining a motion vector for the PU. The data defining the motion vector may describe, for example, a horizontal component of the motion vector, a vertical component of the motion vector, a resolution for the motion vector (e.g., one-quarter pixel precision or one-eighth pixel precision), a reference frame to which the motion vector points, and/or a reference list (e.g., list 0 or list 1) for the motion vector. Data for the leaf-CU defining the PU(s) may also describe, for example, partitioning of the CU into one or more PUs. Partitioning modes may differ depending on whether the CU is uncoded, intra-prediction mode encoded, or inter-prediction mode encoded. For intra coding, a PU may be treated the same as a leaf transform unit described below.

As an example, the HM supports prediction in various PU sizes. Assuming that the size of a particular CU is 2N×2N, the HM supports intra-prediction in PU sizes of 2N×2N or N×N, and inter-prediction in symmetric PU sizes of 2N×2N, 2N×N, Nx2N, or N×N. The HM also supports asymmetric partitioning for inter-prediction in PU sizes of 2N×nU, 2N×nD, nL×2N, and nR×2N. In asymmetric partitioning, one direction of a CU is not partitioned, while the other direction is partitioned into 25% and 75%. The portion of the CU corresponding to the 25% partition is indicated by an “n” followed by an indication of “Up”, “Down,” “Left,” or “Right.” Thus, for example, “2N×nU” refers to a 2N×2N CU that is partitioned horizontally with a 2N×0.5N PU on top and a 2N×1.5N PU on bottom.

In this disclosure, “N×N” and “N by N” may be used interchangeably to refer to the pixel dimensions of a video block in terms of vertical and horizontal dimensions, e.g., 16×16 pixels or 16 by 16 pixels. In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N.

The mode select module 40 may select one of the coding modes, intra or inter, e.g., based on a rate distortion analysis for each mode, and provides the resulting intra- or inter-predicted block (e.g., a prediction unit (PU)) to the summer 50 to generate residual block data and to the summer 62 to reconstruct the encoded block for use in a reference frame. Summer 62 combines the predicted block with inverse quantized, inverse transformed data from inverse transform module 60 for the block to reconstruct the encoded block, as described in greater detail below. Some video frames may be designated as I-frames, where all blocks in an I-frame are encoded in an intra-prediction mode. In some cases, the intra-prediction module 46 may perform intra-prediction encoding of a block in a P- or B-frame, e.g., when motion search performed by the motion estimation module 42 does not result in a sufficient prediction of the block.

The motion estimation module 42 and the motion compensation module 44 may be highly integrated, but are illustrated separately for conceptual purposes. Motion estimation (or motion search) is the process of generating motion vectors, which estimate motion for video blocks. A motion vector, for example, may indicate the displacement of a prediction unit in a current frame relative to a reference sample of a reference frame. The motion estimation module 42 calculates a motion vector for a prediction unit of an inter-coded frame by comparing the prediction unit to reference samples of a reference frame stored in the reference frame buffer 64. A reference sample may be a block that is found to closely match the portion of the CU including the PU being coded in terms of pixel difference, which may be determined by sum of absolute difference (SAD), sum of squared difference (SSD), or other difference metrics. The reference sample may occur anywhere within a reference frame or reference slice, and not necessarily at a block (e.g., coding unit) boundary of the reference frame or slice. In some examples, the reference sample may occur at a fractional pixel position.

The motion estimation module 42 sends the calculated motion vector to the entropy encoding module 56 and the motion compensation module 44. The portion of the reference frame identified by a motion vector may be referred to as a reference sample. The motion compensation module 44 may calculate a prediction value for a prediction unit of a current CU, e.g., by retrieving the reference sample identified by a motion vector for the PU.

The intra-prediction module 46 may intra-predict the received block, as an alternative to inter-prediction performed by the motion estimation module 42 and the motion compensation module 44. The intra-prediction module 46 may predict the received block relative to neighboring, previously coded blocks, e.g., blocks above, above and to the right, above and to the left, or to the left of the current block, assuming a left-to-right, top-to-bottom encoding order for blocks. The intra-prediction module 46 may be configured with a variety of different intra-prediction modes. For example, the intra-prediction module 46 may be configured with a certain number of directional prediction modes, e.g., thirty-five directional prediction modes, based on the size of the CU being encoded.

The intra-prediction module 46 may select an intra-prediction mode by, for example, calculating error values for various intra-prediction modes and selecting a mode that yields the lowest error value. Directional prediction modes may include functions for combining values of spatially neighboring pixels and applying the combined values to one or more pixel positions in a PU. Once values for all pixel positions in the PU have been calculated, the intra-prediction module 46 may calculate an error value for the prediction mode based on pixel differences between the PU and the received block to be encoded. The intra-prediction module 46 may continue testing intra-prediction modes until an intra-prediction mode that yields an acceptable error value is discovered. The intra-prediction module 46 may then send the PU to the summer 50.

The video encoder 20 forms a residual block by subtracting the prediction data calculated by the motion compensation module 44 or the intra-prediction module 46 from the original video block being coded. The summer 50 represents the component or components that perform this subtraction operation. The residual block may correspond to a two-dimensional matrix of pixel difference values, where the number of values in the residual block is the same as the number of pixels in the PU corresponding to the residual block. The values in the residual block may correspond to the differences, i.e., error, between values of co-located pixels in the PU and in the original block to be coded. The differences may be chroma or luma differences depending on the type of block that is coded.

The transform module 52 may form one or more transform units (TUs) from the residual block. The transform module 52 selects a transform from among a plurality of transforms. The transform may be selected based on one or more coding characteristics, such as block size, coding mode, or the like. The transform module 52 then applies the selected transform to the TU, producing a video block comprising a two-dimensional array of transform coefficients. The transform module 52 may select the transform partition according to above-described techniques of this disclosure. In addition, the transform module 52 may signal the selected transform partition in the encoded video bitstream.

The transform module 52 may send the resulting transform coefficients to the quantization module 54. The quantization module 54 may then quantize the transform coefficients. The entropy encoding module 56 may then perform a scan of the quantized transform coefficients in the matrix according to a scanning mode. This disclosure describes the entropy encoding module 56 as performing the scan. However, it should be understood that, in other examples, other processing modules, such as the quantization module 54, could perform the scan. Once the transform coefficients are scanned into the one-dimensional array, the entropy encoding module 56 may apply entropy coding such as CAVLC, CABAC, syntax-based context-adaptive binary arithmetic coding (SBAC), or another entropy coding methodology to the coefficients.

To perform CAVLC, the entropy encoding module 56 may select a variable length code for a symbol to be transmitted. Codewords in VLC may be constructed such that relatively shorter codes correspond to more likely symbols, while longer codes correspond to less likely symbols. In this way, the use of VLC may achieve a bit savings over, for example, using equal-length codewords for each symbol to be transmitted. To perform CABAC, the entropy encoding module 56 may select a context model to apply to a certain context to encode symbols to be transmitted. The context may relate to, for example, whether neighboring values are non-zero or not. The entropy encoding module 56 may also entropy encode syntax elements, such as the signal representative of the selected transform and filter syntax elements, described in greater detail below. In accordance with the techniques of this disclosure, the entropy encoding module 56 may select the context model used to encode these syntax elements based on, for example, an intra-prediction direction for intra-prediction modes, a scan position of the coefficient corresponding to the syntax elements, block type, and/or transform type, among other factors used for context model selection. Following the entropy coding by the entropy encoding module 56, the resulting encoded video may be transmitted to another device, such as the video decoder 30, or archived for later transmission or retrieval.

In some cases, the entropy encoding module 56 or another module of the video encoder 20 may be configured to perform other coding functions, in addition to entropy coding. For example, the entropy encoding module 56 may be configured to determine coded block pattern (CBP) values for CU's and PU's. Also, in some cases, the entropy encoding module 56 may perform run length coding of coefficients.

The inverse quantization module 58 and the inverse transform module 60 apply inverse quantization and inverse transformation, respectively, to reconstruct the residual block in the pixel domain, e.g., for later use as a reference block. The motion compensation module 44 may calculate a reference block by adding the residual block to a predictive block of one of the frames of the reference frame buffer 64. The motion compensation module 44 may also apply one or more interpolation filters to the reconstructed residual block to calculate sub-integer pixel values for use in motion estimation. The summer 62 adds the reconstructed residual block to the motion compensated prediction block produced by the motion compensation module 44 to produce a reconstructed video block.

Deblocking module 43 may receive a plurality of reconstructed video blocks forming a slice or a frame of reconstructed video and filter block boundaries to remove blockiness artifacts from a slice or frame. In one example, deblocking module 43 evaluates the so-called “boundary strength” of a video block. Based on the boundary strength of a video block, edge pixels of a video block may be filtered with respect to edge pixels of an adjacent video block such that the transition from one video block are more difficult for a viewer to perceive. It should be noted that the variables used by a deblocking filter typically can be derived from reconstructed video blocks without a comparison of reconstructed video blocks to the original source video blocks. Thus, video encoder 20 and video decoder 30 may each be programmed to perform the same deblocking process on reconstructed video blocks with minimal additional information regarding the original video frame coded into the bitstream. However, it should be noted that in some cases video encoder 20 may include syntax elements in the bitstream to indicate whether deblocking should be performed and/or whether one of a particular type of deblocking modes should be performed.

SAO/ALF module 45 receives the reconstructed video blocks from deblocking module 43 and may apply SAO and other filtering techniques to the reconstructed video blocks. Filtered reconstructed video blocks may then be stored in the reference frame buffer 64. The reconstructed video block may be used by the motion estimation module 42 and the motion compensation module 44 as a reference block to inter-code a block in a subsequent video frame. As described above, SAO coding techniques may add offset values to pixels in a reconstructed video frame where the offset values are calculated based on the source video frame. Further, other filtering techniques may include the ALF process described in HEVC WD4 and/or Weiner filtering techniques that calculate AC and DC coefficients based on the difference between a source video frame and a reconstructed video frame. Thus, as illustrated in FIG. 4 in addition to outputting SAO/ALF adjusted video blocks to reference frame buffer 64, SAO/ALF module outputs filter syntax elements to entropy encoding module 56 for later use by a video decoder. In addition to including information regarding which filtering processes should be performed, in one example, filter syntax elements may include a set of offset values and filter coefficients. In other examples, filter syntax elements may include information such that a video decoder may determine a set of offset and/or coefficient values.

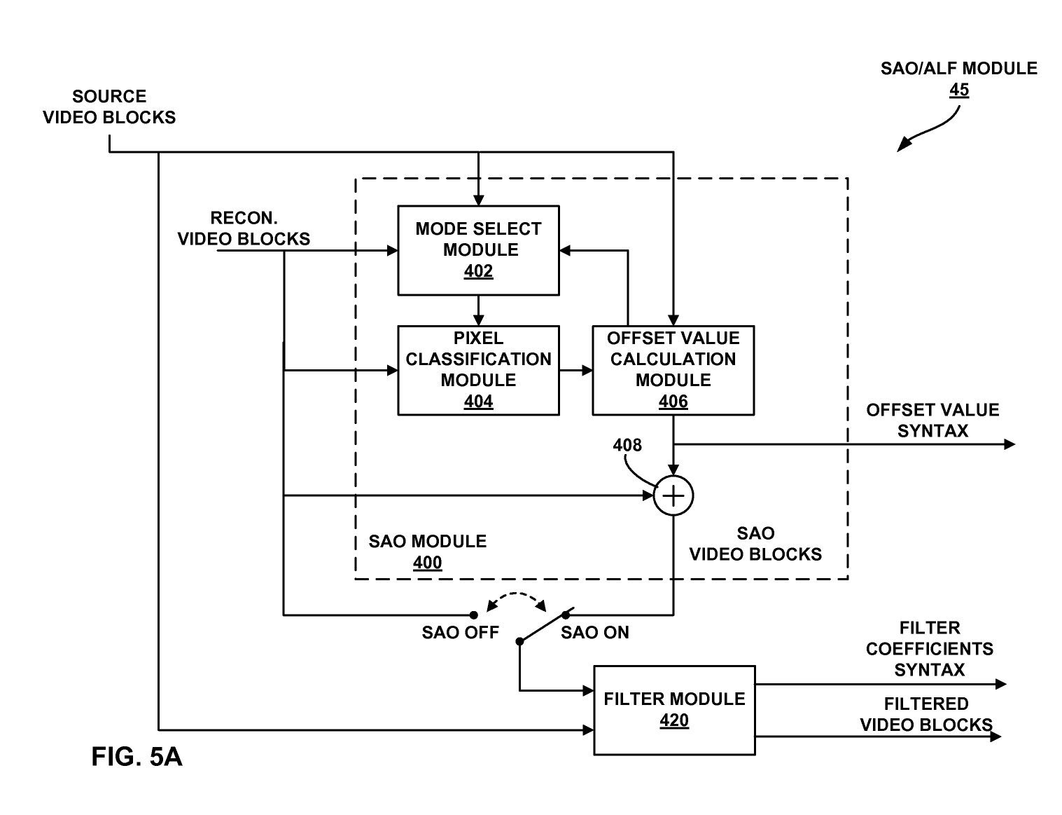

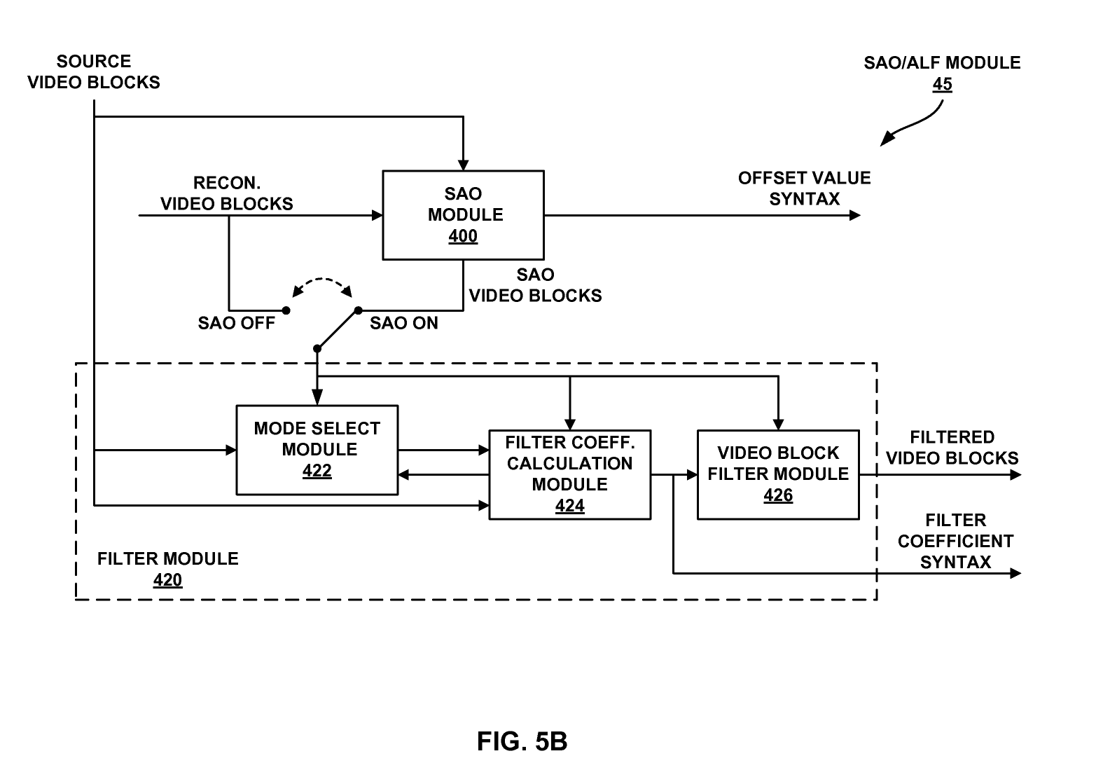

FIGS. 5A and 5B are block diagrams illustrating an example SAO/ALF module included in a video encoder. SAO/ALF module 45 receives reconstructed video blocks and source video blocks as inputs and outputs filtered video blocks and filter syntax (e.g., mode syntax, offset values, and filter coefficients). In some cases, a deblocking filter may have been applied to reconstructed video blocks. SAO/ALF module 45 may generate filtered video blocks by using SAO filtering techniques alone, using other filtering techniques, such as Weiner filtering techniques or the ALF process described in HEVC WD4, alone, or by using SAO filtering techniques and other filtering techniques in combination. The example SAO/ALF module 45 illustrated in FIGS. 5A-5B includes SAO module 400 and filter module 420, where FIG. 5A illustrates an example SAO module 400 in greater detail and FIG. 5B illustrates an example filter module 420 in greater detail.

As illustrated in FIG. 5A, SAO module 400 includes mode select module 402, pixel classification module 404, offset value calculation module 406, and summer 408. SAO module 400, receives reconstructed video blocks and source video blocks as inputs and outputs SAO filtered video blocks and offset value syntax. SAO module 400 may be configured to perform any combination of the edge classification based type SAO techniques, and band classification based offset type SAO techniques described above with respect to FIGS. 1 and 2.

Mode select module 402 may be configured to select between various SAO techniques for a partition of video blocks. In one example, a partition of video blocks may correspond to an LCU in HEVC. In one example, an LCU may be 64×64 pixels. In one example, mode select module 402 is configured to select between not applying an SAO filter, applying a 1D 0-degree edge filter, applying a 1D 90-degree edge filter, applying a 1D 135-degree edge filter, applying a 1D 45-degree edge filter, applying a central band filter or applying a side band filter. In one example, mode select module 402 may be configured to select a mode based on properties of a source video frame, properties of a reconstructed video frame, a reconstruction error, and/or differences between a source video block and a reconstructed video block. In other examples, mode select module 402 may be configured to select an SAO technique based on an iterative process where a plurality of SAO techniques are performed by SAO module 400 and mode select module 402 selects an SAO techniques based on a rate distortion analysis.

Pixel classification module 404 may be configured to receive an indication of an SAO technique from module select module 402 and classifies pixels within a partition accordingly. For example, if the indicated SAO technique is SAO_EO₋1, as described with respect to FIG. 1 above, and a partition includes 4096 (i.e., 64×64) pixels, classification module may calculate an edge type of either −2, −1, 0, 1, or 2 for each of the 4096 pixels based on the values of pixels located above and below a current pixel. As described above, when an adjacent pixel to a current pixel is unavailable for calculating an edge type of a current pixel, pixel classification module 404 may assign a default edge type value (e.g., edge type 0) to a current pixel.

Offset value calculation module 406 may be configured to receive a set of edge type values for a partition and determine a set of corresponding offset values. As described above with respect to FIGS. 1 and 2, offset values may be based on the difference between the original video frame and the reconstructed video frame. In the case of edge classification, in one example, each non-zero edge type value (i.e., −2, −1, 1, and 2) may have one offset value (i.e., eoffset₋₂, eoffset₋₁, eoffset₁, and eoffset₂) calculated by taking an average of differences between the values of original and reconstructed pixels belonging to each category in a partition. Offset value calculation module 406 may output offset values to mode select module 402, as part of an iterative mode selection process. Summer 408 may receive the edge values and the reconstructed video blocks and generate SAO adjusted video blocks by adding the offset values to the reconstructed pixel values.

Further, offset value calculation module 406 may be configured to generate offset value syntax that may be used by a video decoder to reconstruct offset values. In one example, offset value calculation module 406 may generate offset value syntax that indicates an SAO mode and corresponding offset values, where each of the corresponding offset values is represented using with a binary string (e.g., four binary values for four offset values). In one example, offset value calculation module 406 may signal an index to indicate one of the following SAO filter modes: no SAO filter applied, 1D 0-degree edge, a 1D 90-degree edge, 1D 135-degree edge, 1D 45-degree edge, central band filter or side band filter. Further, in one example, offset value calculation module 406 may reduce number of bits required to send a group of offset values by taking advantage of correlations between edge offset values within a group. Thus, instead of representing each offset value individually, offset value calculation module 406 may output syntax elements that allow a video decoder to determine/predict a group of offset values.

With respect to a group of four edge offset values, in some cases, edge offset values exhibit the following correlations. First, there may be a high negative correlation between eoffsetᵢ and eoffset₋ᵢ (with i=1, 2) within a group of offset values. For example, the offset value eoffset₂ is typically equal to −1 multiplied to the offset value eoffset₂. Also, the absolute magnitude of eoffset₋₂ and eoffset₂ are usually larger than the absolute magnitude of eoffset₋₁ and eoffset₁ within the group. Furthermore, a group of four offset values of one partition typically is very close in value to the group of four offset values of a neighboring partition.

Offset value calculation module 406 may be configured to code offset values for a current partition using techniques that exploit these correlations. In one example, offset value calculation module 406 may signal the edge offset values for a current partition in view of the high negative correlation between offset values in the group at the i and −i indexes. For example, if the four original offset values are 10 (eoffset₂), 5 (eoffset₁), −5 (eoffset₋₁), and −10 (eoffset₋₂), rather than signal all four original offset values at their absolute levels, the offset value calculation module 406 may allow for two of the offset values (e.g., the −i values) to be predicted by a decoder. In one example, offset value calculation module may signal the group of offset values as 10 (eoffset₂), 5 (eoffset₁), 0 (eoffset₋₁), and 0 (eoffset₂), or simply as 10 (eoffset₂) and 5 (eoffset₁). Here, eoffset₂ and eoffset₁ may be referred to as original offset values and eoffset₁ and eoffset₂ may be referred to modified offset values. Upon receiving the offset values, a video decoder may multiply the edge offset value eoffset₁ by negative one to obtain the predictor for the edge offset value eoffset₋₁. For example, the predictor for eoffset₋₁ (received as 0 in the above example) is eoffset₁ (received as 5 in the above example) multiplied by negative one. Thus, the predictor for eoffset₋₁ is −5. The predictor of −5 may then be added to the received value of 0 to obtain the offset value of −5. The converse signaling may also be used (i.e., sending 0, 0, −5, −10) by offset value calculation module 406 or video encoder 20. In this manner, a video decoder may generate a group of offset values from one or more received predictor offset values, wherein the one or more received predictor offset values includes an original offset value and a modified offset value. In this manner, fewer bits may used to signal the four offset values. Particularly, when offset values are coded using either unary code or k-th order Golomb code. The following equations depict the prediction techniques for this example.

Predictor of eoffsetᵢ=−eoffset₋ᵢ with i=1,2 or

Predictor of eoffset₋ᵢ=−eoffsetᵢ with i=1,2.

In another example of edge offset coding, offset value calculation module 406 may be configured to signal the edge offset values for a current partition in view of the characteristic that the absolute magnitude of eoffset₋₂ and eoffset₂ are usually larger than the absolute magnitude eoffset₋₁ and eoffset₁. For example, if the four offset values are 10 (eoffset₂), 5 (eoffset₁), −5 (eoffset₋₁), and −10 (eoffset₋₂), rather than signal all four offset values at their absolute levels, the offset value calculation module 406 may allow for a video decoder to predict the two offset values with the larger absolute magnitude (i.e., eoffset₂ and eoffset₋₂) from the two offset values with the smaller absolute magnitudes (i.e., eoffset₁ and eoffset₋₁). For example, the offset value calculation module 406 may modify the values of the two offset values with the larger absolute magnitude (i.e., eoffset₂ and eoffset₋₂). In one example, eoffset₁ may be subtracted from eoffset₂ to produce a modified value of eoffset₂ of 5. Likewise, eoffset₋₁ may be subtracted from effoset₋₂ to produce a modified value of eoffset₋₂ of −5. Offset value calculation module 406 may signal the original values of the two offset values with the smaller absolute magnitudes (i.e., eoffset₁ and eoffset₋₁) and the modified values of the two offset values with the larger absolute magnitude (i.e., eoffset₂ and eoffset₋₂). As such, the signaled offset values in this example would be 5 (eoffset₂), 5 (eoffset₁), −5 (eoffset₋₁), and −5 (eoffset₋₂).

At the decoder, the original values of offset value eoffset₂ and eoffset₋₂ may be recovered by adding back the predictor (i.e., eoffset₁ and eoffset₋₂). The following equations depict the prediction techniques for this example.

Predictor of eoffset₋₂=eoffset₋₁+eoffset₋₂ and/or

Predictor of eoffset₂=eoffset₁+eoffset₂

A further reduction of bits used to signal the offset values may be accomplished by combining both of the above techniques. For example, a predictor for eoffset₋ᵢ may be used as well as a predictor for eoffset₂. That is:

Predictor of eoffset₂=eoffset₁+eoffset₂ and

Predictor of eoffset₋ᵢ=−eoffsetᵢ with i=1,2.

For example, if the four offset values are 10 (eoffset₂), 5 (eoffset₁), −5 (eoffset₋₁), and −10 (eoffset₋₂). Eoffset₂ may be predicted from eoffset₁ and sent as 5. Eoffset₋₁ may be predicted from −1*eoffset₁ and may be sent as 0. Likewise, eoffset₋₂ may be predicted from −1*eoffset₂ and sent as 0. As such, the signaled offset values are 5 (eoffset₂), 5 (eoffset₁), 0 (eoffset₋₁), and 0 (eoffset₋₂), thus further reducing the number of bits that are signaled. The converse signaling may also be used where:

Predictor of eoffset−₂=eoffset−₁+eoffset₋₂ and

Predictor of eoffsetᵢ=−eoffset−ᵢ with i=1,2.

In another example, offset value calculation module 406 may be configured to use the edge offset values of a neighboring partition to signal the edge offset values for a current partition. The neighboring partition may be a partition that is causal to the current partition (i.e., the neighboring partition has already been encoded). The offset value calculation module 406 may be configured to subtract the offset values of a current partition from the offset values of a neighbor partition that also utilizes edge offset coding to generate predicted offset values. The predicted offset values would then be signaled in the encoded video bitstream. Offset value calculation module 406 would also then signal an index identifying the neighboring partition whose offset values were used to generate the predicted offset values. This technique exploits the likelihood that the offset values in neighboring partitions are close in value to those of the current partition. Examples of neighboring partitions include the partitions above or to the left of the current partition, or partitions in previously encoded frames. It should be noted that when neighboring partitions are not available (i.e., no SAO is used or no edge offset is used), some prefixed value (e.g., 1 or 2 or average values over previous frames) value can be used as a predictor.

The following equations depict one prediction technique where the edge offset values of a current partition are derived from a neighboring partition.

Predictor of eoffset₋ᵢ=neighbor eoffset₋ᵢ(with i=1,2)and/or

Predictor of eoffsetᵢ=neighbor eoffsetᵢ(with i=1,2)

According to the technique provided by the equations above, a video decoder uses the offset values of a neighbor partition indicated by the index, as well as the received predicted offset values, to reconstruct the offset values for a current partition.

In one example, offset value calculation module 406 may be configured such that only a partial set of the four edge offset values are predicted from offset values of a neighboring partition (e.g., predictor of eoffset₋ᵢ=neighbor eoffset₋ᵢ (with i=1,2)). For example, if offset₋₁ of the current partition is −5 and eoffset₋₂ of the current partition is −10 and eoffset₋₁ of a neighbor partition is −4 and eoffset₋₂ of the neighbor partition is −9, the predicted values for eoffset₋₁ and eoffset₋₂ for the current partition may be −1 and −1 (i.e., −10 minus −9, and −5 minus −4). Further, the remaining two offset values for the current partition (i.e., eoffset₁ and eoffset₂) may then also be predicted with one of the aforementioned techniques. For example, the predictor of eoffsetᵢ may be -eoffset₋ᵢ for i=1 and 2. In another example, the predictor of eoffset₂ may be equal eoffset₁. For each of the edge offset value prediction techniques described above, offset value calculation module 406 may be configured to code the offset values using either unary code or k-th order Golomb code with different k values for different coefficients.

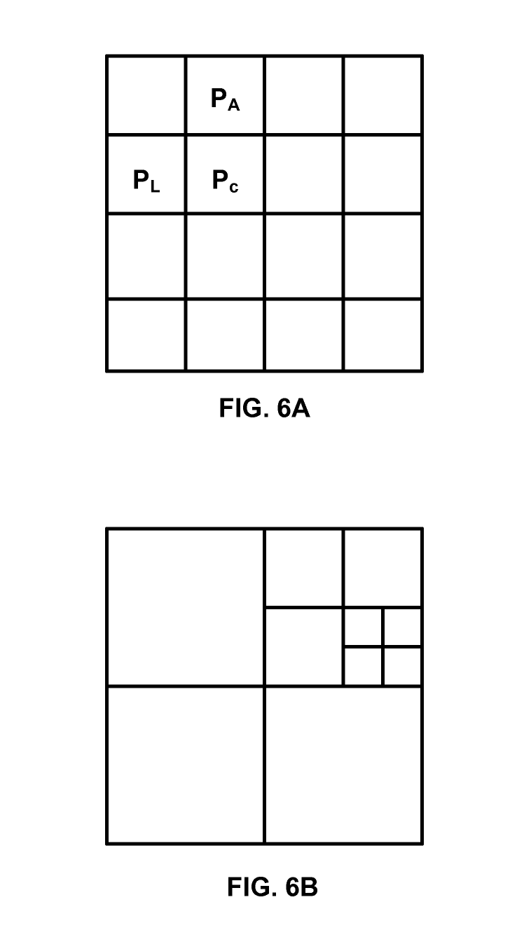

FIGS. 6A and 6B are conceptual diagrams illustrating examples of a current partition and neighboring partitions of a video frame. As illustrated in FIG. 6A neighboring partitions (P_{L}, P_{A}) may be located to the left of and above a current partition, P_{c}. In one example, partitions may be formed by dividing a video frame into 16 regions. In this case, FIG. 6A may represent a video frame divided into 16 regions. In one example, partitions may coincide with LCUs define according to HEVC. In this case, FIG. 6A may represent a region of a video frame including 16 LCUs. FIG. 6B further illustrates an example decomposition of a partition shown in FIG. 6A. As described above, HEVC allows for LCUs to be further split for purposes of defining TUs and PUs. Thus, in one example, sub-blocks in FIG. 6B may represent CUs, TUs, or PUs defined according to a quad-tree structure. Thus, partitions may be defined for filtering purposes as various levels of a video block coding structure.

As described above, SAO module 400 may be configured to perform band classification based offset type SAO techniques. Thus, offset value calculation module 406 may be configured to code band offset values (i.e., boffset₀, . . . , boffset₁₅). Offset value calculation module 406 may be configured to reduce the number of bits required to send the group sixteen band offset values by taking advantage of correlations between band offset values within the group.

Band offset values also exhibit similar correlations to the edge offset values described above. In some cases, there is a high negative correlation between boffsetᵢ and boffset₁₅₋ᵢ with i=0, 1, 2 within a group of band offset values. Also, the absolute magnitude of boffset₀ and boffset₁₅ are usually bigger than the absolute magnitude of boffset₁ and boffset₁₄. It should be noted that these correlations exist at the beginning and end values of the band. As such, prediction within the group of band offset values may be used for band offset values 0, 1, 2 and/or 13, 14, 15.

Offset value calculation module 406 may be configured to code edge band offset values for a current partition using techniques that exploit these correlations. In one example, offset value calculation module 406 may be configured to signal the band offset values for a current partition in view of the high negative correlation between offset values boffsetᵢ and boffset₁₅₋ᵢ, where i=0, 1, 2. In this example, a video decoder may be configured to generate boffsetᵢ by multiplying boffset₁₅₋ᵢ by negative one. The following equation depicts the prediction techniques for this example.

Predictor of boffsetᵢ=−boffset₁₅₋ᵢ with i=0,1,2

Further, offset value calculation module 406 may be configured to signal the edge offset values for a current partition in view of the characteristic that the absolute magnitude of boffset₀ and boffset₁₅ are usually larger than the absolute magnitude of boffset₁ and boffset₁₄. In one example, offset value calculation module 406 may be configured to code the predictor for boffsetᵢ (where i=0, 1, 2) or boffset₁₅₋ᵢ (where i=0, 1, 2) according to the following equations:

Predictor of boffsetᵢ=boffsetᵢ₊₁ with i=0,1,2 and/or

Predictor of boffset₁₅₋ᵢ=boffset₁₅₋ᵢ₋₁ with i=0,1,2

In addition to the band offset values correlations described above, the group of sixteen band offset values of one partition may be very close in value to the group of sixteen band offset values of a neighboring partition. Thus, offset value calculation module 406 may signal band offset values using technique that exploit the likelihood of the band offset values in neighboring partitions being close in value to those of a current partition. In one example, offset value calculation module 406 may be configured to signal the band offset values such that a video decoder predicts the sixteen offset values of a current partition from the sixteen offset values of a neighbor partition that also utilizes band offset coding. That is, offset value calculation module 406 generates predicted offset values for a current partition by subtracting the offset values of the current partition from the offset values of a neighboring partition. The neighboring partition may be a partition that is causal to the current partition (i.e., the neighboring partition has already been encoded). Examples of neighboring partitions include the partitions above or to the left of the current partition, or partitions in previously encoded frames.

The following equation depicts one prediction technique where the band offset values of a current partition are derived from a neighboring partition.

Predictor of boffsetᵢ=neighbor boffsetᵢ(with i=0, . . . ,15)

According to the technique provided by the equation above, a video decoder uses the offset values of a neighbor partition, as well as the received predicted offset values, to reconstruct the offset values for a current partition. In this case, offset value calculation module 406 may signal an index identifying the neighbor partition from which a video decoder should use to derive band offset values for a current partition.

As discussed above, offset value calculation module 406 may signal the difference between the offset values of the current partition and the offset values of the neighbor partition. The offset value calculation module 406 may signal the difference in band offset values as well as the index of the neighbor partition used as the predictor. It should be noted that when neighboring partitions are not available (i.e., no SAO is used or no band offset is used), some prefixed value (e.g., 1, 2, or average values over previous frames) value can be used as a predictor. For each of the band offset value prediction techniques described above, the band offset values to be signaled may be coded using either unary code or k-th order Golomb code with different k values for different coefficients.

Referring again to FIGS. 5A and 5B, as described above SAO/ALF module 45 may generate filtered video blocks by using SAO filtering techniques in conjunction with other filtering techniques that use AC and DC filtering coefficients. As illustrated in FIG. 5B, filter module 420 includes mode select module 422, filter coefficient calculation module 424, and video block filter module 426. Filter module 420, receives reconstructed video blocks and source video blocks as inputs and outputs filtered video blocks and filter coefficient syntax. Filter module 420 may be configured to perform filtering techniques, such as Weiner filtering techniques or ALF techniques described in HEVC WD4.

Mode select module 422 may be configured to select between various filtering techniques for a partition of video blocks. In one example, mode select module 422 may be configured to select a mode based on properties of a source video frame, properties of a reconstructed video frame, a reconstruction error, and/or differences between a source video block and a reconstructed video block. In other examples, mode select module 422 may be configured to select a filtering technique based on an iterative process where a plurality of filter techniques are performed by filter module 420 and mode select module 422 selects a filtering technique based on a rate distortion analysis.

Filter coefficient calculation module 424 is configured to receive a filter mode type and generate filter coefficient syntax elements. Filter coefficient syntax elements may include an indication of a filter technique, a filter tap size, and a set of filter coefficients. As described above, filtering techniques may include AC and DC coefficients. Filter coefficient calculation module 424 may output filter coefficients to mode select module 422, as part of an iterative mode selection process. Further, filter coefficient calculation module 424 may output filter coefficient syntax to be used by a video decoder to determine filter coefficients. Video block filter module 426 receives the filter coefficients and the reconstructed video blocks and generates filtered video blocks using an identified filtering technique. For example, video block filter module 426 may generate filtered reconstructed video blocks based on a weighted sum that includes AC and DC filter coefficients.

Further, filter coefficient calculation module 424 may be configured to generate filter coefficient syntax that may be used by a video decoder to reconstruct coefficient values. As described above, because the SAO process adds an offset value to pixels, in some cases, the addition of DC coefficients to SAO filtered pixels in additional filtering processes may be redundant. Further, in some cases coding efficiencies may be gained when DC coefficients are coded with less precision than AC coefficients and not all AC coefficients benefit from the high precision coding. SAO/ALF module 45 may be configured to signal filter coefficients to a video decoder based on these characteristics.

In one example, filter coefficient calculation module 424 and offset value calculation module 406 of SAO/ALF module 45 may be configured such that DC coefficients generated by filter coefficient calculation module 424 are signaled at a lower precision than the precision used to signal offset values when SAO filtering is applied to a reconstructed video block. It should be noted that in some cases, when SAO filtering is applied and a filtering techniques that utilizes DC coefficients is applied, the SAO offset values may be equal to the DC coefficients and may be referred to as such. According to one example, SAO/ALF module 45 may signal the DC coefficients (i.e., the edge offset values and/or band offset values) and/or some portion of AC coefficients in an encoded video bitstream at a lower precision than some AC coefficients. Signaling DC coefficients at a lower precision may be accomplished by right shifting the bits of a DC coefficient to remove the lowest significant bits. For example, the SAO/ALF module may signal following lower bit precision coefficients instead of the original coefficients.

Coeffcients_sent=(Coefficients_original+(1<<(shift−1)))>>shift.

In the equation above, the variable “shift” represents the number of right shifts used to create the lower precision coefficients. In some examples, the original coefficients may first be left shifted by a number of shifts one less than desired number of right shifts. This process effectively rounds the original coefficients before they are divided by the right shift process. The number of shifts used may be different for each coefficient depending on how much precision is needed to accurate reproduce the coefficient within some predetermined threshold.

A video decoder may reconstruct an approximation of the original coefficients (i.e., Coefficient′ in the equation below) by left shifting the sent coefficients a number of times equal to how many right shifts were performed by SAO/ALF module 45. The number of shifts may be preset at both a video encoder and video decoder or may be signaled by a video encoder in the encoded video bitstream. Shifting at the decoder may be done according to the following equation:

Coefficient′=Coeffcients_sent<<shift.

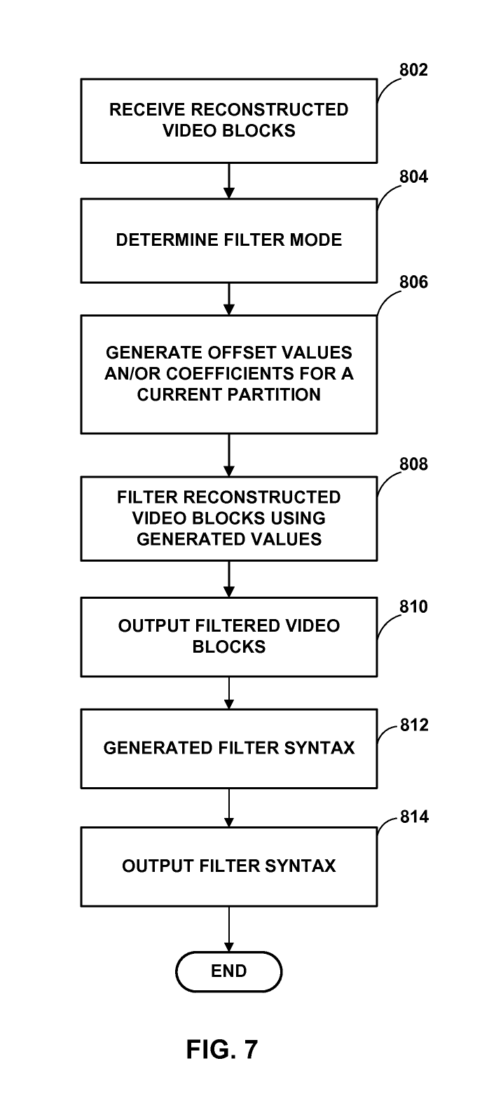

In this manner, video encoder 20, SAO/ALF module 45, SAO module 400, filter module 420, offset value calculation module 406 and/or filter coefficient calculation module 424 may be configured to code/signal offset values and filter coefficients in an efficient manner. FIG. 7 is a flowchart illustrating an example of applying filtering techniques and encoding filter syntax according to the techniques of this disclosure. Although the process in FIG. 7 is described below with respect to video SAO/ALF module 45, the process may be performed by any combination of video encoder 20, SAO/ALF module 45, SAO module 400, filter module 420, offset value calculation module 406 and filter coefficient calculation module 424.

SAO/ALF module 45 receives reconstructed video blocks (802). Reconstructed video blocks may be generated according to a predictive coding technique. In some case a deblocking filter may be applied to reconstructed video blocks before they are received by SAO/ALF module 45. SAO/ALF module 45 determines a filter mode (804). In one example, the filter mode may be selected from any combination of no SAO filter applied, 1D 0-degree edge, a 1D 90-degree edge, 1D 135-degree edge, 1D 45-degree edge, central band filter, side band filter, Weiner filters and ALF filer processes. SAO/ALF module 45 generates SAO offsets and filter coefficients for a current partition based on the filter mode (806). In one example, a partition may be a 64×64 LCU defined according to HEVC. SAO/ALF module 45 filters reconstructed video blocks using the generated SAO offsets and filter coefficients (808). Filtering the reconstructed video blocks may include adding SAO offsets to pixel values in reconstructed video blocks and/or multiplying pixels values by filter coefficients. SAO/ALF module 45 outputs filtered reconstructed video blocks (810). Filtered reconstructed video blocks may be output to a reference frame buffer to be used for subsequent predictions. SAO/ALF module 45 generates filter syntax elements (812). Filter syntax may include any of the syntax elements described above and may further include any syntax elements that allow a video decoder to determine a filtering technique and filter values associated with the filter technique. In one example, generating filter syntax may include determining one or more predictor offset values to be used by a video decoder to generate the group of offset values for the current partition. SAO/ALF module 45 outputs filter syntax (814). SAO/ALF module 45 may out filter syntax to an entropy encoder, such as entropy encoder 56 described above.

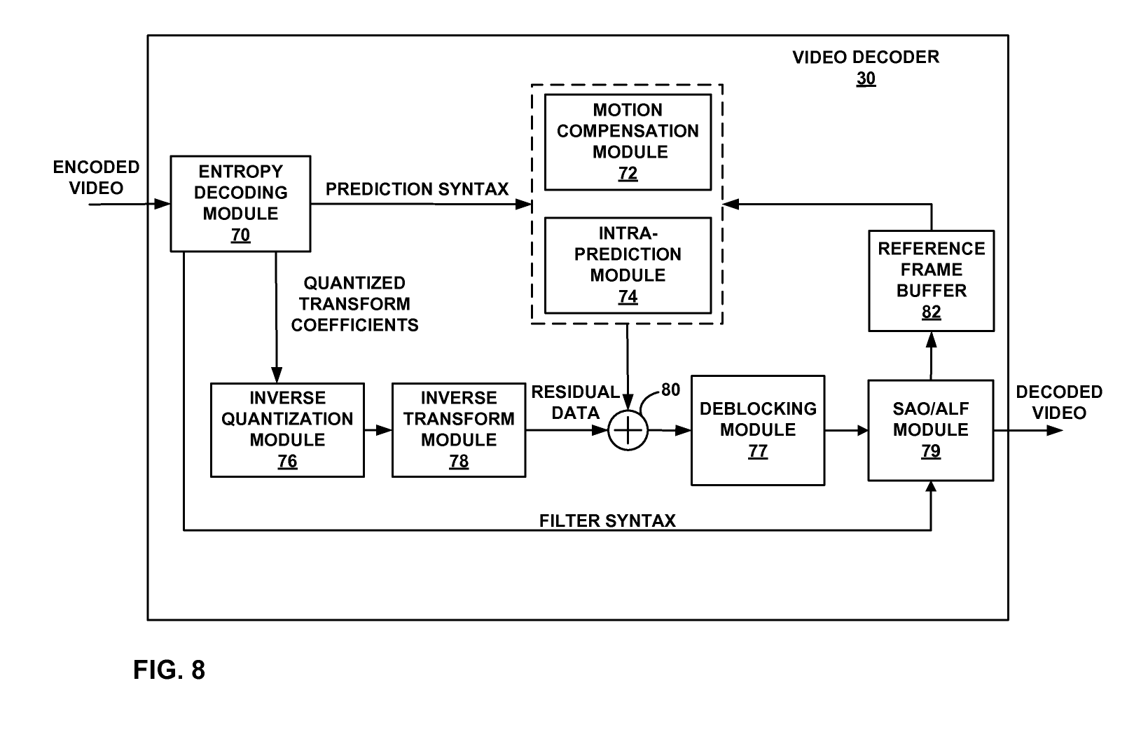

FIG. 8 below is a block diagram illustrating an example of a video decoder 30, which decodes an encoded video sequence. In the example of FIG. 8, the video decoder 30 includes entropy decoding module 70, motion compensation module 72, intra-prediction module 74, inverse quantization module 76, deblocking module 77, inverse transformation module 78, reference frame buffer 82, SAO/ALF module 79, and summer 80. The video decoder 30 may, in some examples, perform a decoding pass generally reciprocal to the encoding pass described with respect to the video encoder 20.

The entropy decoding module 70 performs an entropy decoding process on the encoded bitstream to retrieve a one-dimensional array of transform coefficients. The entropy decoding process used depends on the entropy coding used by the video encoder 20 (e.g., CABAC, CAVLC, etc.). The entropy coding process used by a video encoder may be signaled in the encoded bitstream or may be a predetermined process.

In some examples, the entropy decoding module 70 (or the inverse quantization module 76) may scan the received values using a scan mirroring the scanning mode used by the entropy encoding module 56 (or the quantization module 54) of the video encoder 20. Although the scanning of coefficients may be performed in the inverse quantization module 76, scanning will be described for purposes of illustration as being performed by the entropy decoding module 70. In addition, although shown as separate functional modules for ease of illustration, the structure and functionality of the entropy decoding module 70, the inverse quantization module 76, and other modules of the video decoder 30 may be highly integrated with one another. Further, entropy decoding module 70 may entropy decode syntax elements, such as filter syntax element described above.

The inverse quantization module 76 inverse quantizes, i.e., de-quantizes, the quantized transform coefficients provided in the bitstream and decoded by the entropy decoding module 70. The inverse quantization process may include a conventional process, e.g., similar to the processes proposed for HEVC or defined by the H.264 decoding standard. The inverse quantization process may include use of a quantization parameter QP calculated by the video encoder 20 for the CU to determine a degree of quantization and, likewise, a degree of inverse quantization that should be applied. The inverse quantization module 76 may inverse quantize the transform coefficients either before or after the coefficients are converted from a one-dimensional array to a two-dimensional array.

The inverse transform module 78 applies an inverse transform to the inverse quantized transform coefficients. In some examples, the inverse transform module 78 may determine an inverse transform based on signaling from the video encoder 20, or by inferring the transform from one or more coding characteristics such as block size, coding mode, or the like. In some examples, the inverse transform module 78 may determine a transform to apply to the current block based on a signaled transform at the root node of a quadtree for an LCU including the current block. Alternatively, the transform may be signaled at the root of a TU quadtree for a leaf-node CU in the LCU quadtree. In some examples, the inverse transform module 78 may apply a cascaded inverse transform, in which inverse transform module 78 applies two or more inverse transforms to the transform coefficients of the current block being decoded.

The intra-prediction module 74 may generate prediction data for a current block of a current frame based on a signaled intra-prediction mode and data from previously decoded blocks of the current frame. Based on the retrieved motion prediction direction, reference frame index, and calculated current motion vector, the motion compensation module 72 produces a motion compensated block for the current portion. These motion compensated blocks essentially recreate the predictive block used to produce the residual data. The motion compensation module 72 may produce the motion compensated blocks, possibly performing interpolation based on interpolation filters. Identifiers for interpolation filters to be used for motion estimation with sub-pixel precision may be included in the syntax elements. The motion compensation module 72 may use interpolation filters as used by the video encoder 20 during encoding of the video block to calculate interpolated values for sub-integer pixels of a reference block. The motion compensation module 72 may determine the interpolation filters used by the video encoder 20 according to received syntax information and use the interpolation filters to produce predictive blocks.

Additionally, the motion compensation module 72 and the intra-prediction module 74, in an HEVC example, may use some of the syntax information (e.g., provided by a quadtree) to determine sizes of LCUs used to encode frame(s) of the encoded video sequence. The motion compensation module 72 and the intra-prediction module 74 may also use syntax information to determine split information that describes how each CU of a frame of the encoded video sequence is split (and likewise, how sub-CUs are split). The syntax information may also include modes indicating how each split is encoded (e.g., intra- or inter-prediction, and for intra-prediction an intra-prediction encoding mode), one or more reference frames (and/or reference lists containing identifiers for the reference frames) for each inter-encoded PU, and other information to decode the encoded video sequence. The summer 80 combines the residual blocks with the corresponding prediction blocks generated by the motion compensation module 72 or the intra-prediction module 74 to form decoded blocks.

Deblocking module 77 may receive a plurality of reconstructed video blocks forming a slice or a frame of reconstructed video and filter block boundaries to remove blockiness artifacts from a slice or frame. Deblocking module 77 may operate in a similar manner to deblocking module 43 described above. In one example, deblocking module 77 evaluates the so-called “boundary strength” of a video block. Based on the boundary strength of a video block, edge pixels of a video block may be filtered with respect to edge pixels of an adjacent video block.

The SAO/ALF module 79 receives filter syntax and reconstructed video blocks and outputs filtered reconstructed video blocks. The SAO/ALF module 79 operates in accordance with the filter techniques described above with respective to FIG. 1 and FIG. 2 for example. SAO/ALF module 79 may output the filtered video blocks to reference frame buffer 82 and/or to a display (such as the display device 32 of FIG. 3). When filter video blocks are stored in the reference frame buffer 82, they may be used as reference blocks for subsequent motion compensation.

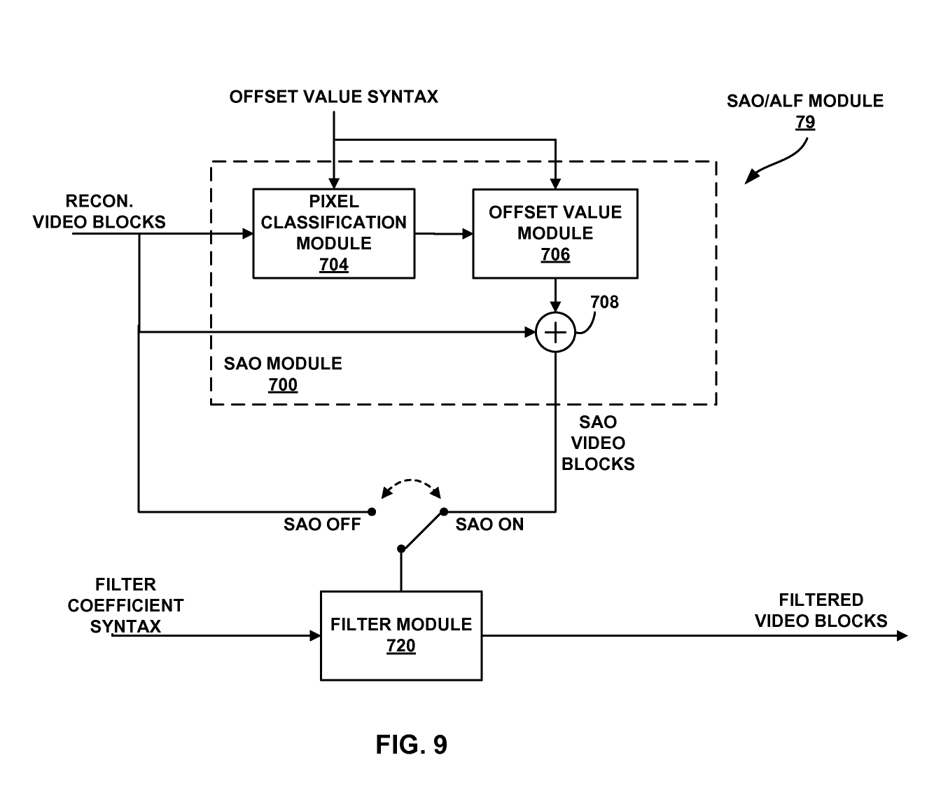

FIG. 9 is a block diagram illustrating an example SAO/ALF module included in a video decoder. SAO/ALF module 79 receives reconstructed video blocks and filter syntax (e.g., mode syntax, offset values, and filter coefficients) as inputs and outputs filtered video blocks. SAO/ALF module 79 may generate filtered video blocks by using SAO filtering techniques alone, using other filtering techniques, such as Weiner filtering techniques or the ALF process described in HEVC WD4, alone, or by using SAO filtering techniques and other filtering techniques in combination. In most cases, SAO/ALF module 79 will perform a filtering consistent with a filter process performed by a video encoder. Thus, SAO/ALF module 79 may be configured such that it can perform any of the example filter techniques described above with respect to SAO/ALF module 45. For the sake of brevity, a detailed description of filtering techniques described with respect to SAO/ALF module 79 will not be repeated. However, it should be noted that SAO/ALF 45 may refer to an original video frame while determining a filtering mode and performing a filtering process, whereas SAO/ALF module 79 relies on information included in an encoded bitstream. The example SAO/ALF module 79 illustrated in FIG. 9 includes SAO module 700 and filter module 720. SAO module 700 includes pixel classification module 704, offset value calculation module 706, and summer 708.

In one example, pixel classification module 704 may be configured to receive an indication of an SAO technique from offset value syntax and classifies pixels based on the pixel values of a reconstructed video block. For example, pixel classification module 704 may classify pixels based on the techniques described above with respect to FIGS. 1 and 2. In should be noted that in some cases, the pixel classifications values may be included in the offset value syntax. As described above, when an adjacent pixel to a current pixel is unavailable for calculating an edge type of a current pixel, pixel classification module 704 may assign a default edge type value (e.g., edge type 0) to a current pixel.

Offset value module 706 may be configured to receive a set of offset type values for a partition and determine a set of corresponding offset values from offset value syntax. As described in the examples above with respect to FIG. 5A, offset value syntax may be based on signaling techniques that signal each offset value explicitly or techniques that that utilizes correlations between offset values. Offset value module 706 may be configured to determine offset values and to perform the reciprocal coding process to any of the coding processes described above with reference to FIGS. 5A and 5B. Summer 708 may receive the offset values and the reconstructed video blocks and generate SAO adjusted video blocks by adding the offset values to the reconstructed pixel values.

As described above, SAO filtering techniques may be used in conjunction with other filtering techniques that use AC and DC filtering coefficients. Filter module 720, receives reconstructed video blocks, which may be filter using an SAO filtering process, and filter coefficient syntax as inputs and outputs filtered video blocks. Filter module 720 may be configured to perform any of the filtering techniques described above, such as Weiner filtering techniques or ALF techniques described in HEVC WD4. In this manner, video decoder 30, SAO/ALF module 79, SAO module 700, filter module 720, and/or offset value module 706 may be configured to determine offset values and filter coefficients from information included in an encoded bitstream.

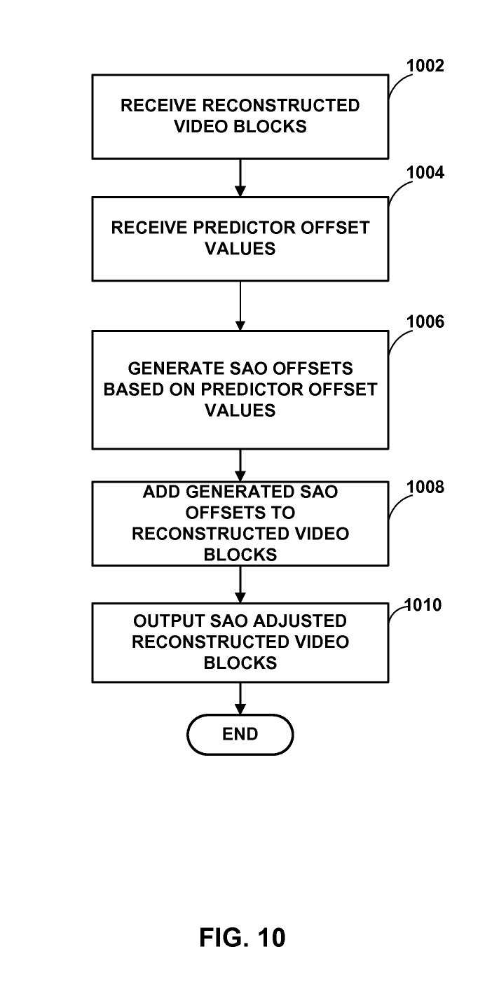

FIG. 10 is a flowchart illustrating an example of determining filter values and applying filtering techniques according to the techniques of this disclosure. Although the process in FIG. 10 is described below with respect to video SAO/ALF module 79, the process may be performed by any combination of video decoder 30, SAO/ALF module 79, SAO module 700, filter module 720, and offset value module 706. In one example, filter values may be associated with any combination of the following filtering techniques: 1D 0-degree edge, a 1D 90-degree edge, 1D 135-degree edge, 1D 45-degree edge, central band filter, side band filter, Weiner filters and ALF filer processes.

SAO/ALF module 79 receives reconstructed video blocks (1002). Reconstructed video blocks may be generated according to a predictive coding technique. Reconstructed video blocks may form a partition as described with respect to FIGS. 6A and 6B. In one example, a partition may be a 64×64 LCU defined according to HEVC. In some cases a deblocking filter may be applied to reconstructed video blocks before they are received by SAO/ALF module 79. SAO/ALF module 79 receives predictor offsets values (1004). Predictor offset values may be generated by using any of the techniques describes above. In one example, one or more predictor offset values may be offset values associated with a neighboring partition. SAO/ALF module 79 generates SAO offsets values based on predictor offset values (1006). In some examples, generating offset values may include performing arithmetic operations on received predictor offset values. SAO/ALF module 79 filters reconstructed video blocks by adding the generated SAO offsets to the reconstructed video blocks (1008). SAO/ALF module 79 outputs filtered reconstructed video blocks (1010). Filtered reconstructed video blocks may be output to a reference frame buffer to be used for subsequent predictions and/or to a display.

In one or more examples, the functions described may be implemented in hardware, software, firmware, or any combination thereof. If implemented in software, the functions may be stored on or transmitted over, as one or more instructions or code, a computer-readable medium and executed by a hardware-based processing module. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interpretive hardware units, including one or more processors as described above, in conjunction with suitable software and/or firmware.

Various examples have been described. These and other examples are within the scope of the following claims.

What is claimed is:

1. A method of filtering video data comprising:
receiving a current partition of a video coding unit;
receiving a modified offset value associated with the current partition;
receiving one or more predictor offset values;
generating a group of offset values for the current partition based on the modified offset value and the one or more predictor offset values; and
filtering the current partition based on the generated group of offset values.

2. The method of claim 1, wherein generating a group of offset values for the current partition based on the modified offset value and the one or more predictor offset values includes adding a predictor offset value to the modified offset value.

3. The method of claim 2, wherein the one or more predictor offset values are offset values associated with a neighboring partition; and further comprising receiving an index identifying the neighboring partition.

4. The method of claim 2, wherein generating a group of offset values for the current partition based on the modified offset value and the one or more predictor offset values further includes negating the value of the predictor offset value.

5. The method of claim 1, wherein the modified offset value is modified from an original offset value associated with the current partition such that the modified offset values includes fewer bits than the original offset value.

6. The method of claim 1, further comprising receiving an index identifying an SAO filter mode from a set of SAO filter modes, wherein the set of SAO filter modes includes: no SAO filter applied, 1D 0-degree edge, 1D 90-degree edge, 1D 135-degree edge, 1D 45-degree edge, central band filter, and side band filter.

7. A method of encoding filter offset values in a video coding process comprising:
determining a group of offset values for a current partition of a video coding unit;
determining one or more predictor offset values;
generating a modified offset value by modifying one of the offset values in the group of offset values based on the one or more predictor offset values; and
signaling the modified offset value and the one or more predictor offset values in an encoded video bitstream.

8. The method of claim 7, wherein modifying one of the offset values in the group of offset values includes subtracting a predictor offset value from one of the offset values in the group of offset values.

9. The method of claim 8, wherein the one or more predictor offset values are offset values associated with a neighboring partition; and wherein signaling the one or more predictor offset values includes signaling an index identifying the neighboring partition.

10. The method of claim 8, wherein modifying one of the offset values in the group of offset values further includes negating the value of one of the offset values in the group of offset values.

11. The method of claim 7, wherein the modified offset value includes fewer bits than one of the offset values in the group of offset values.

12. The method of claim 7, further comprising signaling an index identifying an SAO filter mode from a set of SAO filter modes, wherein the set of SAO filter modes includes: no SAO filter applied, 1D 0-degree edge, 1D 90-degree edge, 1D 135-degree edge, 1D 45-degree edge, central band filter, and side band filter.

13. An apparatus configured to filter video data comprising:
means for receiving a current partition of a video coding unit;
means for receiving a modified offset value associated with the current partition;
means for receiving one or more predictor offset values;
means for generating a group of offset values for the current partition based on the modified offset value and the one or more predictor offset values; and
means for filtering the current partition based on the generated group of offset values.

14. The apparatus of claim 13, wherein generating a group of offset values for the current partition based on the modified offset value and the one or more predictor offset values includes adding a predictor offset value to the modified offset value.

15. The apparatus of claim 14, wherein the one or more predictor offset values are offset values associated with a neighboring partition; and further comprising means for receiving an index identifying the neighboring partition.

16. The apparatus of claim 14, wherein generating a group of offset values for the current partition based on the modified offset value and the one or more predictor offset values further includes negating the value of the predictor offset value.

17. The apparatus of claim 13, wherein the modified offset value is modified from an original offset value associated with the current partition such that the modified offset values includes fewer bits than the original offset value.

18. The apparatus of claim 13, further comprising means for receiving an index identifying an SAO filter mode from a set of SAO filter modes, wherein the set of SAO filter modes includes: no SAO filter applied, 1D 0-degree edge, 1D 90-degree edge, 1D 135-degree edge, 1D 45-degree edge, central band filter, and side band filter.

19. An apparatus configured to encode filter offset values in a video coding process comprising:
means for determining a group of offset values for a current partition of a video coding unit;
means for determining one or more predictor offset values;
means for generating a modified offset value by modifying one of the offset values in the group of offset values based on the one or more predictor offset values; and
means for signaling the modified offset value and the one or more predictor offset values in an encoded video bitstream.

20. The apparatus of claim 19, wherein modifying one of the offset values in the group of offset values includes subtracting a predictor offset value from one of the offset values in the group of offset values.

21. The apparatus of claim 20, wherein the one or more predictor offset values are offset values associated with a neighboring partition; and wherein signaling the one or more predictor offset values includes signaling an index identifying the neighboring partition.

22. The apparatus of claim 20, wherein modifying one of the offset values in the group of offset values further includes negating the value of one of the offset values in the group of offset values.

23. The apparatus of claim 19, wherein the modified offset value includes fewer bits than one of the offset values in the group of offset values.

24. The apparatus of claim 19, further comprising means for signaling an index identifying an SAO filter mode from a set of SAO filter modes, wherein the set of SAO filter modes includes: no SAO filter applied, 1D 0-degree edge, 1D 90-degree edge, 1D 135-degree edge, 1D 45-degree edge, central band filter, and side band filter.

25. A device comprising a video decoder configured to:
receive a current partition of a video coding unit;
receive one or more predictor offset values;
generate a group of offset values for the current partition based on the one or more predictor offset values; and
filter the current partition based on the generated group of offset values.

26. The device of claim 25, wherein configured to generate a group of offset values for the current partition based on the modified offset value and the one or more predictor offset values includes configured to add a predictor offset value to the modified offset value.

27. The device of claim 26, wherein the one or more predictor offset values are offset values associated with a neighboring partition; and wherein the video decoder is further configured to receive an index identifying the neighboring partition.

28. The device of claim 26, wherein configured to generate a group of offset values for the current partition based on the modified offset value and the one or more predictor offset values further includes configured to negate the value of the predictor offset value.

29. The device of claim 25, wherein the modified offset value is modified from an original offset value associated with the current partition such that the modified offset values includes fewer bits than the original offset value.

30. The device of claim 25, wherein the video decoder is further configured to receive an index identifying an SAO filter mode from a set of SAO filter modes, wherein the set of SAO filter modes includes: no SAO filter applied, 1D 0-degree edge, 1D 90-degree edge, 1D 135-degree edge, 1D 45-degree edge, central band filter, and side band filter.

31. A device comprising a video encoder configured to:
determine a group of offset values for a current partition of a video coding unit;
determine one or more predictor offset values;
generate a modified offset value by modifying one of the offset values in the group of offset values based on the one or more predictor offset values; and
signal the modified offset value and the one or more predictor offset values in an encoded video bitstream.

32. The device of claim 31, wherein modifying one of the offset values in the group of offset values includes subtracting a predictor offset value from one of the offset values in the group of offset values.

33. The device of claim 32, wherein the one or more predictor offset values are offset values associated with a neighboring partition; and wherein configured to signal the one or more predictor offset values includes configured to signal an index identifying the neighboring partition.

34. The device of claim 32, wherein modifying one of the offset values in the group of offset values further includes negating the value of one of the offset values in the group of offset values.

35. The device of claim 31, wherein the modified offset value includes fewer bits than one of the offset values in the group of offset values.

36. The device of claim 31, wherein the video encoder is further configured to signal an index identifying an SAO filter mode from a set of SAO filter modes, wherein the set of SAO filter modes includes: no SAO filter applied, 1D 0-degree edge, 1D 90-degree edge, 1D 135-degree edge, 1D 45-degree edge, central band filter, and side band filter.

37. A non-transitory computer-readable storage medium having instructions stored thereon that upon execution cause one or more processors of a video coding device to:
receive a current partition of a video coding unit;
receive one or more predictor offset values;
generate a group of offset values for the current partition based on the one or more predictor offset values; and
filter the current partition based on the generated group of offset values.

38. The non-transitory computer-readable storage medium of claim 37, wherein to generate a group of offset values for the current partition based on the modified offset value and the one or more predictor offset values includes adding a predictor offset value to the modified offset value.

39. The non-transitory computer-readable storage medium of claim 38, wherein the one or more predictor offset values are offset values associated with a neighboring partition; and wherein the instructions further cause one or more processors of a video coding device to receive an index identifying the neighboring partition.

40. The non-transitory computer-readable storage medium of claim 38, wherein to generate a group of offset values for the current partition based on the modified offset value and the one or more predictor offset values further includes negating the value of the predictor offset value.

41. The non-transitory computer-readable storage medium of claim 37, wherein the modified offset value is modified from an original offset value associated with the current partition such that the modified offset values includes fewer bits than the original offset value.

42. The non-transitory computer-readable storage medium of claim 37, wherein the instructions further cause one or more processors of a video coding device to receive an index identifying an SAO filter mode from a set of SAO filter modes, wherein the set of SAO filter modes includes: no SAO filter applied, 1D 0-degree edge, 1D 90-degree edge, 1D 135-degree edge, 1D 45-degree edge, central band filter, and side band filter.

43. A non-transitory computer-readable storage medium having instructions stored thereon that upon execution cause one or more processors of a video encoding device to:
determine a group of offset values for a current partition of a video coding unit;
determine one or more predictor offset values;
generate a modified offset value by modifying one of the offset values in the group of offset values based on the one or more predictor offset values; and
signal the modified offset value and the one or more predictor offset values in an encoded video bitstream.

44. The non-transitory computer-readable storage medium of claim 43, wherein modifying one of the offset values in the group of offset values includes subtracting a predictor offset value from one of the offset values in the group of offset values.

45. The non-transitory computer-readable storage medium of claim 44, wherein the one or more predictor offset values are offset values associated with a neighboring partition; and wherein to signal the one or more predictor offset values includes signaling an index identifying the neighboring partition.

46. The non-transitory computer-readable storage medium of claim 44, wherein modifying one of the offset values in the group of offset values further includes negating the value of one of the offset values in the group of offset values.

47. The non-transitory computer-readable storage medium of claim 43, wherein the modified offset value includes fewer bits than one of the offset values in the group of offset values.

48. The non-transitory computer-readable storage medium of claim 43, wherein the instructions further cause one or more processors of a video coding device to signal an index identifying an SAO filter mode from a set of SAO filter modes, wherein the set of SAO filter modes includes: no SAO filter applied, 1D 0-degree edge, 1D 90-degree edge, 1D 135-degree edge, 1D 45-degree edge, central band filter, and side band filter.
